(19) United States
(12) Patent Application Publication
(10) Pub. No.: US 2005/0273618 A1
(43) Pub. Date: Dec. 8, 2005

(54) Information recording medium, information recording device, information reproduction device, information delivery device, their methods, their programs, and recording medium recording programs thereon

(76) Inventors: Itaru Takemura, SAITAMA (JP); Kazuhiko Yoshida, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/525,956

(22) PCT Filed: Aug. 27, 2003
(86) PCT No.: PCT/JP03/10839

§ 371 Date: Feb. 28, 2005

(30) Foreign Application Priority Data
Sep. 11, 2002 (JP) 2002-265769

(51) Int. Cl. H04K 1/00

(52) U.S. Cl. 713/182

(57) ABSTRACT

Contents encrypted by content encryption keys AE_{R1}, AE_{R34} and content decryption keys AD_{R1}, AD_{R34} encrypted by encryption keys BE₄, BE₆, BE₇ are recorded on recording media 301, 302. The encryption keys BE₄, BE₆, BE₇ differ among playback regions 1 to 4 preset to control the permission and inhibition of content playback. Content playback regions can be limited by using only the encryption keys of regions where playback is permitted. Even if a key is leaked out, the other playback regions are not affected because the encryption keys differ among playback regions and therefore the copyright protection function is increased.

### TECHNICAL FIELD

The present invention relates to an information recording medium, an information recording device, an information playback device, an information delivery device, their methods, their programs and a recording medium recording the programs thereon.

### BACKGROUND ART

As a recording medium (information recording medium) for recording contents (information, data) of multimedia data and the like such as music and images, there is used optical disk of DVD (Digital Versatile Disc) and the like. In such optical disk, in order to protect the copyright of contents, a method, in which flags unique to regions called as region code (regional code) are used to limit regions permitted to play the recording medium, is employed.

That is to say, region codes are provided to both of optical disk and playback device (playback equipment and playback software), which plays information recorded in the optical disk. When playing the optical disk, the playback device reads a region code included in the optical disk, and only when the region code agrees with the region code of its own, the playback is permitted; thereby playback regions are limited.

Since the contents recorded on such optical disk are digital data, even when the data are copied, the data does not deteriorate. Accordingly, once the contents have been copied from the optical disk in an unauthorized manner, considerable disadvantage will be caused to the copyright holder. Therefore, in addition to the above-described region code for limiting the playback regions, recently the following technique has been employed to protect the copyright; that is, the contents themselves recorded on optical disk are encrypted so that, even when the contents are copied in an unauthorized manner, the data are prevented from being viewed.

Specifically, it is arranged so that contents recorded on optical disk are previously encrypted using a predetermined encryption key, and the encrypted contents are decrypted using a decryption key, which is owned by playback device, and played thereby.

In order to ensure the effectiveness of copyright protection, it is necessary to allow the medium side to manage the permission and inhibition of playback of the contents by a particular playback device such as a playback device of which decryption key is leaked out, or the like. Therefore, it is arranged so that different decryption keys are provided to each of the playback devices, and, in order to make playback of the contents inhibited (i.e., to make the particular playback device revoked), what need to do is to encrypt the content using an encryption key which can not be decrypted by the decryption key owned by the particular playback device, and record it on the optical disk.

Here, such method in which an encryption key has a one-to-one correspondence to the contents is available. However, from the needs of security to revoke a particular playback device, or the like, in the case where it is necessary to use plural encryption keys, every contents, each encrypted with respective encryption key, have to be recorded on the recording medium. Therefore, there is a problem in the point of recording capacity.

Therefore, the following method has been employed; that is, a decryption key for decrypting the contents is encrypted with another encryption key, and a decryption key for decrypting the encryption key is previously incorporated in each of the playback devices.

However, in the case that each of the playback devices is recorded with only one decryption key, a content decryption key has to be encrypted with an encryption key, which matches with all decryption keys owned by the playback devices, has to be recorded in the optical disk. Even if the size of each of the encrypted content decryption keys is small, when the number of the playback devices becomes large, the data volume also becomes larger. Therefore, it is hardly put to practical use.

Therefore, in order to reduce the number of the encrypted content decryption keys to be recorded in optical disk, plural decryption keys, which are managed in a hierarchical architecture using a tree structure or the like, are prepared beforehand; and each of the playback devices is recorded with plural decryption keys so that the combination of the decryption keys is different from each other among the playback devices.

By employing the arrangement as described above, the following advantage can be obtained. That is, even in the case where a decryption key used in a particular playback device is leaked out, when a new optical disk recorded with the contents is manufactured, by using an encryption key matching with a decryption key which is not provided to the particular playback device, it is possible to prevent playback of the contents by the particular playback device. Thus, the disadvantage at the leakage of the key can be minimized.

In the system as described above, it is possible to reduce the number of the decryption keys for encrypted contents to be recorded in optical disk. On the other hand, compared to the case where only one decryption key is recorded in each of the playback devices, it is necessary to manage a large number of keys. That is, the optical disk has to be recorded with decryption keys for contents encrypted by encryption keys corresponding to each of the decryption keys. The playback device side also has to be recorded with many decryption keys.

As a method for effectively managing the plural keys as described above, the following documents 1 and 2 describe a key management system having a tree structure.

Document 1: D. Naor, M. Naor, and J. Lotspiech, “Revocation and Tracing Scheme for Stateless Receivers,” Proceedings of CRYPTO 2001, Lecture Notes in Computer Science, Vol. 2139, pp. 41-62, 2001.

Document 2: Nakano Toshihisa, Omori Motoshi, Matsuzaki Natsume, Tatebayashi Makoto, “Key Management System for Digital Content Protection—Tree Pattern Division Method—” Proceedings of the 2002 Symposium on Cryptography and Information Security, pp. 715-720.

Document 1 describes a complete sub-tree method, which is a key management system using the tree structure. In this method, as shown in FIG. 1, each playback device is allotted to respective leaf position (a node positioned at the lowermost layer in the tree structure). Also, each node including a root (a node positioned at the uppermost layer in the tree structure) and leaves are allotted respectively with one encryption key BEᵢ and one decryption key BDᵢ corresponding thereto. The encryption key BEᵢ and the decryption key BDᵢ have such relationship that a cipher encrypted using the encryption key BEᵢ can be decrypted by a playback device having a decryption key BDᵢ, which has the same suffix “ᵢ”; and mate with each other on the one-to-one basis. In FIG. 1, only the decryption key BDᵢ is indicated as the representative but the corresponding encryption key BEᵢ is omitted.

On the other hand, each of the playback devices is previously provided with decryption keys BD_{i,} which are included in a path from the node, to which the playback device itself is allotted, to the root.

In the example shown in FIG. 1, there are 16 playback devices, and each of the playback devices 1-16 has 5 decryption keys BDᵢ. For example, a playback device 4 is provided with 5 decryption keys BD₁, BD₂, BD₄, BD₉, and BD₁₉, which are marked with a circle in FIG. 1. Generally, the number of the decryption keys BDᵢ owned by a playback device is; log₂N+1, assuming that the total number of the playback devices is N.

In the case where playback permission is given to all playback devices 1-16, the medium 401 is recorded with Encryption (content decryption key AD, encryption key BE₁) and Encryption (contents, content encryption key AE). Here, the Encryption ( ) represents an encryption algorithm; and the Encryption (argument 1, argument 2) represents a cipher-text, in which the argument 1 is encrypted by using the argument 2 as the encryption key.

Accordingly, the medium 401 is recorded with contents encrypted by the content encryption key AE and a content decryption key AD encrypted by the encryption key BE₁. Every playback device 1-16 owns the decryption key BD₁ corresponding to the encryption key BE₁. Accordingly, when playing the medium 401, each of the playback devices 1-16 decrypts the content decryption key AD using the decryption key BD₁ of its own, and then, decrypts the contents using the content decryption key AD to play the contents.

On the other hand, when revoking particular (one or plural) playback device(s), (namely, to set up the medium so that the contents can not be played by the playback device(s)), a new content encryption key AE₂ for encrypting the contents and a content decryption key AD₂ corresponding thereto are prepared first, and the contents are encrypted by using the new content encryption key AE₂.

Then, the following sub-trees are created, the sub-tees including the minimum number of the playback devices in the sub-trees covering every playback device excluding the playback device to be revoked. And the content decryption key AD₂ is encrypted by the encryption keys BEᵢ allotted to the root of the sub-tees.

For example, as shown in FIG. 2, when revoking the playback device 4, the content decryption key AD₂ is encrypted by using decryption keys BD₃, BD₅, BD₈ and BD₁₈ so that the decryption key owned by the playback device 4 is not included.

And, the encrypted contents (encrypted contents=Encryption (contents, content encryption key AE₂)) and the encrypted content decryption key AD₂ (AD₂=Encryption (content decryption key AD₂, encryption key BE₃)|Encryption (content decryption key AD₂, encryption key BE₅)|Encryption (content decryption key AD₂, encryption key BE₈)|Encryption (content decryption key AD₂, encryption key BE₁₈)) are recorded in the new medium 402. The symbol “|” means that two pieces of the data are combined with each other.

Owing to the above arrangement, the new medium 402 can not be played by the playback device 4 but can be played by other playback devices.

In this case, compared to the case of the medium 401, the number of the encrypted content decryption keys AD₂ to be record in the medium 402 is larger, and the upper limit of the number is expressed as rlog₂(N/r), assuming that the number of the playback devices to be revoked is “r”; and the total number of playback devices is “N”. However, since the data volume of the content decryption key is much smaller than that of the contents, it will not be a considerable problem in the point of the storage capacity even if the number thereof increases to a certain extent.

The method disclosed in the document 2 is a method called as tree pattern division method. In plural nodes in each layer of a tree structure, the node which includes a playback device to be revoked in the sub-node thereof is represented by “1”; and the node without the same is represented by “0”. These values are combined with each other from the left end of the tree structure in order to create a node revocation pattern. And these node revocation patterns are allotted with encryption keys (decryption keys) different from each other. Thereby, the number of the decryption keys owned by the playback devices is prevented from increasing as well as the size of the key information to be recorded in a recording medium is made smaller.

These techniques set forth in the documents 1 and 2 are used for revocation of decryption key in specific playback devices without having any connection with the playback control in the limited region based on the region code.

In the case of the prior art which uses the above-described region code, the region code recorded in the recording medium such as optical disk and the region code of the playback device are simply compared to each other to determine whether or not the both agree with each other. Accordingly, for example, there resides the following problem. That is, if the region code of the medium side or the playback device side is rewritten in an unauthorized manner, or a region code comparator in the playback device side is removed therefrom, a medium or a playback device capable of playback in any region can be obtained relatively easily.

Also, in the case of the technique which revokes specific playback device using a tree structured key management system as set forth in the above documents 1 and 2, the playback function based on the limited region like region code is not provided. Accordingly, when limiting the regions where playback is permitted, the region code has to be used together. Accordingly, for example, a problem accompanying the case where the region code is used also arises.

Further, when the encryption key or the decryption key is broken through, in every recording medium, the content decryption key and the content encryption key have to be changed. Accordingly, for example, such problem resides in; i.e., countermeasure against the above is hard to be taken.

### DISCLOSURE OF THE INVENTION

In view of above-described problems, it is therefore an object of the present invention to provide an information recording medium capable of limiting playback regions to enhance the copyright protection function, an information recording device, an information playback device, an information delivery device, their methods, their programs and a recording medium recording the program thereon.

An aspect of the present invention is to provide an information recording medium recording contents encrypted using a content encryption key, and a content decryption key used for decrypting the encrypted contents and encrypted by an encryption key for decryption key, wherein the encryption key for decryption key is different for each of the regions preset for at least controlling the permission and inhibition of playback of the contents, the content encryption key and the content decryption key are established corresponding to each of the regions where the content playback is permitted, or corresponding to the combination of the regions where content playback is permitted.

Another aspect of the present invention is to provide an information recording device which comprises: a content encryption key inputting section for establishing and inputting a content encryption key corresponding to each of the regions where playback of the contents is permitted, or corresponding to combination of the regions where content playback is permitted, a content decryption key inputting section for establishing and inputting a content decryption key utilized for decrypting the contents encrypted by the content encryption key, an encryption key for decryption key selecting section for selecting an encryption key for decryption key corresponding to the region where playback of the contents is permitted, a content encryption section for encrypting the contents utilizing the content encryption key, a content decryption key encrypting section for encrypting the content decryption key using the encryption key for decryption key, and a recording section for recording at least the encrypted contents and the encrypted content decryption key to an information recording medium.

A further aspect of the present invention is to provide an information playback device for playing information including contents encrypted utilizing a content encryption key, and a content decryption key used for decrypting the encrypted contents and encrypted by an encryption key for decryption key, the device comprising: a decryption key storing section storing a decryption key for decryption key for decrypting the content decryption key encrypted by the encryption key for decryption key, a content decryption key decrypting section for decrypting the content decryption key by using the decryption key for decryption key, a content decrypting section for decrypting the contents by utilizing the content decryption key, and a playback section for playing the decrypted contents; wherein the decryption keys for decryption key is different for each of the regions preset for at least controlling the permission and inhibition of the content playback, the content encryption key and the content decryption key are established corresponding to each of the regions where content playback is permitted, or corresponding to the combination of the regions where content playback is permitted.

Still another aspect of the present invention is to provide an information delivery device which comprises: a delivery section for delivering contents encrypted utilizing a content encryption key, and content decryption key used for decrypting the encrypted contents and encrypted by an encryption key for decryption key.

Still another aspect of the present invention is to provide an information recording method which comprises the steps of: obtaining selection information of the regions where playback of the contents is permitted, establishing a content encryption key and a content decryption key corresponding to the selected regions or the combination thereof, obtaining an encryption key for decryption key preset in accordance with the selected region, encrypting the contents utilizing the content encryption key, encrypting the content decryption key using the encryption key for decryption key, and recording the encrypted contents and the encrypted content decryption key to an information recording medium.

Still another aspect of the present invention is to provide an information playback method for playing information including contents encrypted utilizing a content encryption key, and a content decryption key used for decrypting the encrypted contents and encrypted by an encryption key for decryption, wherein the decryption key for decryption key is different for each of the regions preset at least for controlling the permission and inhibition of the content playback, the content encryption key and the content decryption key are established corresponding to the each of the regions where content playback is permitted or, in accordance with the combination of regions where content playback is permitted, the method comprising the steps of: checking whether or not an information playback device has a decryption key for decryption key corresponding to the encryption key for decryption key encrypting the content decryption key, decrypting the content decryption key using the decryption key for decryption key when the information playback device has the corresponding decryption key for decryption key, decrypting the contents utilizing the decrypted content decryption key, and playing the decrypted contents.

Still another aspect of the present invention is to provide an information recording program, wherein the program causes a computer to execute any of the aforesaid information recording methods.

Still another aspect of the present invention is to provide a recording medium recording an information recording program, wherein the aforesaid information recording program is recorded so as to be read out by a computer.

### BRIEF DESCRIPTION OF DRAWINGS

FIG. 1 is a schematic diagram showing a key management system in a prior art of the present invention,

FIG. 2 is a schematic diagram showing a key management system in a prior art of the present invention,

FIG. 3 is a block diagram showing the configuration of a recording device in a fist embodiment of the present invention,

FIG. 4 is a diagram showing a data format of a signal S1 in FIG. 3,

FIG. 5 is a diagram showing a data format of the signal S2 in FIG. 3,

FIG. 6 is a diagram showing a data format of the signal S3 in FIG. 3,

FIG. 7 is a diagram showing a data format of the signal S4 in FIG. 3,

FIG. 8 is a diagram showing a data format of the signal S5 in FIG. 3,

FIG. 9 is a diagram showing a data format of the signal S6 in FIG. 3,

FIG. 10 is a diagram showing a data format of the signal S7 in FIG. 3,

FIG. 11 is a block diagram showing the configuration of a playback device in the first embodiment,

FIG. 12 is a diagram showing a data format of a signal S11 in FIG. 11,

FIG. 13 is a diagram showing a data format of the signal S12 in FIG. 11,

FIG. 14 is a diagram showing a data format of the signal S13 in FIG. 11,

FIG. 15 is a diagram showing a data format of the signal S14 in FIG. 11,

FIG. 16 is a diagram showing a data format of the signal S15 in FIG. 11,

FIG. 17 is a diagram showing a data format of the signal S16 in FIG. 11,

FIG. 18 is a schematic diagram showing a key management system in the first embodiment,

FIG. 19 is a schematic diagram showing a key management system in the first embodiment,

FIG. 20 is a flowchart showing a processing step in the recording device of the first embodiment,

FIG. 21 is a flowchart showing a processing step in the playback device of the first embodiment,

FIG. 22 is a schematic diagram showing a key management system in a second embodiment of the present invention,

FIG. 23 is a schematic diagram showing a key management system in a third embodiment of the present invention,

FIG. 24 is a schematic diagram showing the key management system in the third embodiment,

FIG. 25 is a schematic diagram showing the key management system in the third embodiment, and

FIG. 26 is a block diagram showing the configuration of a record playback system in a fourth embodiment of the present invention.

### BEST MODES FOR CARRYING OUT THE INVENTION

Now, embodiments of the present invention will be described by referring to the accompanying drawings.

### First Embodiment

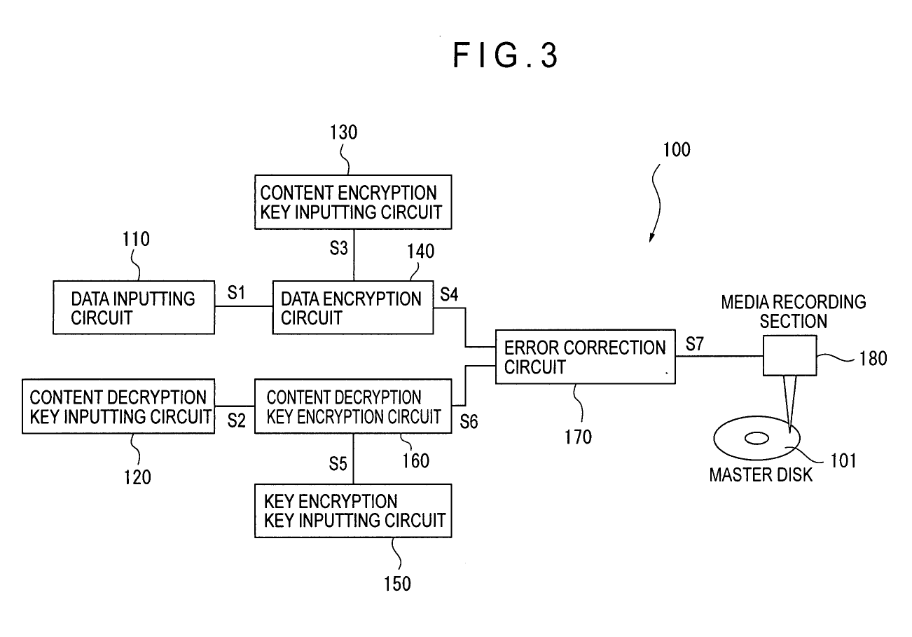

First, a first embodiment of the present invention will be described by referring to FIG. 3 to FIG. 21.

The present embodiment is a record and playback system including a recording device 100 as an information recording device for recording information (contents) on a recording medium as an information recording medium and a playback device 200 as an information playback device for playing the information on the recording medium.

### Configuration of the Recording Device

The configuration of the recording device 100 according to the embodiment will be described by referring to the block diagram of FIG. 3. The recording device 100 writes contents on a master disk 101 for optical disk as a recording medium.

In the recording device 100 shown in FIG. 3, the detail of the cutting method (master disk manufacturing method) of the master disk 101 and manufacturing method of optical disks and the like for playback only of DVD-ROM (Digital Versatile Disc—Read Only Memory) on which information is previously recorded using the manufactured master disk 101 are well known. Therefore, illustrations and detailed descriptions thereof will be omitted here.

As shown in FIG. 3, the recording device 100 is provided with a data inputting circuit 110, a content decryption key inputting circuit 120 as a content decryption key inputting section, a content encryption key inputting circuit 130 as a content encryption key inputting section, a data encryption circuit 140 as a content encryption section, a key encryption key inputting circuit 150 as a decryption-key encryption key selecting section, a content decryption key encryption circuit 160 as a content decryption key encryption section, an error correction circuit 170, and a media recording section 180 as a recording section.

Each of the circuits 110, 120, 130, 140, 150, 160 and 170 may be comprised of an exclusive hardware respectively. Or the recording device 100 may be provided with hardware resources such as a central processing unit (CPU) and a main memory, and the function of each circuit may be achieved as collaboration between the hardware resources and a program, which is installed into the CPU to be executed.

The data inputting circuit 110 is a circuit for inputting contents, which is to be recorded on optical disk as a recording medium, to the recording device 100. Ordinarily, the contents are various kinds of multimedia data such as music and images. However, the contents are not limited to the above, but can be ordinary document data or the like. The data inputting circuit 110 outputs a signal S1, which is the input contents, to the data encryption circuit 140.

As for the data inputting circuit 110, for example, a circuit which reads a recording medium such as magnetic tape or DVD-RW recorded with master data of contents and outputs the signal S1; a circuit which accesses a computer recorded with master data of contents via a communication line such as a LAN and the Internet, and downloads the data to read and output the signal S1, and the like are available.

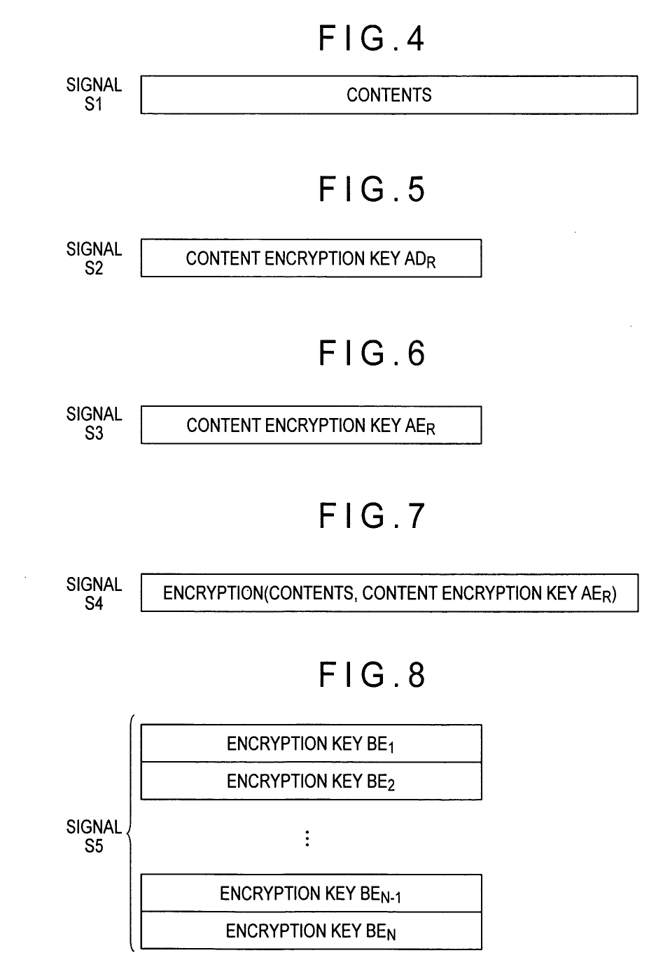

An example of data format of the signal S1 is shown in FIG. 4. The signal S1 comprises contents (data) only.

The content decryption key inputting circuit 120 is a circuit which inputs a content decryption key AD_{R} for decrypting the contents. The content decryption key inputting circuit 120 outputs the input content decryption key AD_{R} as a signal S2 to the content decryption key encryption circuit 160. Here, as the content decryption key AD_{R}, values different from each other among the regions where playback of the contents is permitted, or among the combinations of the regions, are input. Specifically, when one or more regions, where playback of the contents is permitted, are selected from preset playback permitted regions by a content owner, the content decryption key inputting circuit 120 sets up the content decryption key AD_{R} in accordance with the combination of the selected regions (including the case where there is only a single region), and outputs the key as a signal S2.

An example of data format of the signal S2 is shown in FIG. 5. The signal S2 is constituted by the content decryption key AD_{R} only.

The playback permitted regions are, like conventional region code, preset to set up the permission and inhibition of content playback. Specifically, in accordance with the region code, the global regions may be set up as “North America, Japan, Europe, Arab, Southeast Asia, South America, Australia, Africa, Russia, South Asia and China.” Further, in a more detailed manner, the regions may be set up based on country or district of country.

The content encryption key inputting circuit 130 is a circuit for inputting a content encryption key AE_{R}. The content encryption key inputting circuit 130 outputs the input content encryption key AE_{R} as a signal S3 to the data encryption circuit 140. Here, the content encryption key AE_{R} and the content decryption key AD_{R} are set up so that the following relationship is established; i.e., P=Decryption (Encryption (arbitrary data P, content encryption key AE_{R}), content decryption key AD_{R}). Accordingly, like the content decryption key AD_{R}, the content encryption key AE_{R} is also set up based on regions, where playback of the contents is permitted, or combination thereof.

An example of data format of the signal S3 is shown in FIG. 6. The signal S3 is comprised of the content encryption key AE_{R} only.

Here, the Decryption ( ) represents a decryption algorithm. The Decryption (argument 1, argument 2) represents the data in which the argument 1 is decrypted by the argument 2 as the decryption key. Accordingly, the above P represents the data in which a cipher-text of arbitrary data P encrypted using the content encryption key AE_{R} is decrypted using the content decryption key AD_{R}.

The data encryption circuit 140 is a circuit, which encrypts the signal S1 (S1=contents) using the signal S3 (S3=content encryption key AE_{R}), and outputs a signal S4 (S4=Encryption (contents, content encryption key AE_{R})). Accordingly, the signal S4 is contents encrypted using the content encryption key AE_{R}. An example of data format of the signal S4 is shown in FIG. 7.

The key encryption key inputting circuit 150 is a circuit which inputs encryption key (encryption key for decryption-key) BEᵢ for encrypting the content decryption key AD_{R}. Here, the encryption keys BEᵢ are different for each of the regions, which are preset to at least manage the permission and inhibition of content playback. An encryption key BEᵢ is selected and input in accordance with the regions where playback of the contents is permitted.

Therefore, in the case where playback is permitted in plural regions, for example, plural encryption keys BEᵢ are occasionally input. For example, when N encryption keys of BE₁, BE₂, . . . , BEᵢ, . . . BE_{N-1}, and BE_{N} are input, the key encryption key inputting circuit 150 outputs a signal S5 (S5=encryption key BE₁|encryption key BE₂|. . . |encryption key BEᵢ|. . . |encryption key BE_{N-1}|encryption key BE_{N}). Accordingly, the signal S5 is a piece of data, in which plural encryption keys BEᵢ input by the key encryption key inputting circuit 150 are combined with each other. An example of data format of the signal S5 is shown in FIG. 8.

The content decryption key encryption circuit 160 is a circuit, which encrypts the signal S2 (S2=content decryption key AD_{R}) using each of the encryption keys BEᵢ included in the signal S5 and adds header information of Header (encryption key BEᵢ) thereto and outputs a signal S6.

Here, the signal S6=Header(encryption key BE₁)|Encryption (content decryption key AD_{R}, encryption key BE₁)|Header(encryption key BE₂)|Encryption (content decryption key AD_{R}, encryption key BE₂)|. . . |Header(encryption key BEᵢ)|Encryption (content decryption key AD_{R}, encryption key BEᵢ)|. . . |Header(encryption key BE_{N-1})|Encryption (content decryption key AD_{R}, encryption key BE_{N-1})|Header(encryption key BE_{N})|Encryption (content decryption key AD_{R}, encryption key BE_{N}).

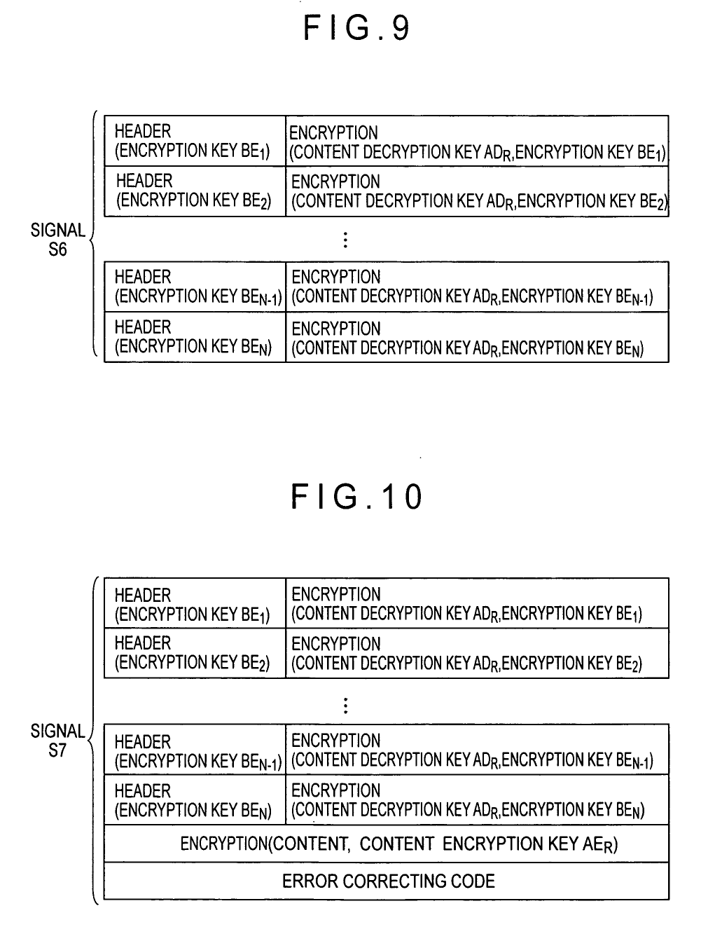

Hereinafter, in order to simplify the expression, the signal S6 is expressed as: signal S6=Header (encryption key BEᵢ)|Encryption (content decryption key AD_{R}, encryption key BEᵢ). That is, as shown in FIG. 9, the signal S6 is constituted by the content decryption key AD_{R} encrypted using the plural encryption keys BEᵢ and the header information Header (encryption key BEᵢ).

The header information Header (encryption key BEᵢ) is the information used for identifying the encryption key BEᵢ used.

The error correction circuit 170 is a device, which inputs the signal S4 (S4=Encryption (contents, content encryption key AE_{R})) and the signal S6 (S6=Header (encryption key BEᵢ)|Encryption (content decryption key AD_{R}, encryption key BEᵢ)), combines them with each other and adds an error correction code thereto, and outputs them as signal S7.

As shown in FIG. 10, the signal S7 is a signal comprised of contents encrypted by the content encryption key AE_{R}, N content decryption keys AD_{R} encrypted by N encryption keys BEᵢ, header information of each of the encryption keys BEᵢ and an error correction code. That is, S7=Header (encryption key BEᵢ)|Encryption (content decryption key AD_{R}, encryption key BEᵢ)|Encryption (contents, content encryption key AE_{R})|ECC.

Here, ECC stands for an error correction code. Incidentally, the detail of the method for error correction using the ECC is well-known technique; so, the description thereof will be omitted.

The media recording section 180 is a device which records the input signal S7 to a recording medium such as an optical disk or a master disk for manufacturing optical disks. For example, when the master disk 101 is used as the recording medium, a laser oscillator for cutting master disk is used as the media recording section 180. On the other hand, when a various kinds of optical media, which are capable of recording such as DVD-R, DVD-RW, DVD-RAM and CD-R, is used as the recording medium, a laser oscillator for recording data is used as the media recording section 180.

Incidentally, as the recording medium on which data are recorded by the media recording section 180, when a large amount of optical disks is manufactured, generally, the master disk 101 is used. When a small amount of optical disks is manufactured in a manner of on-demand production or the like, a various kinds of recording optical disk is used.

### Configuration of the Playback Device

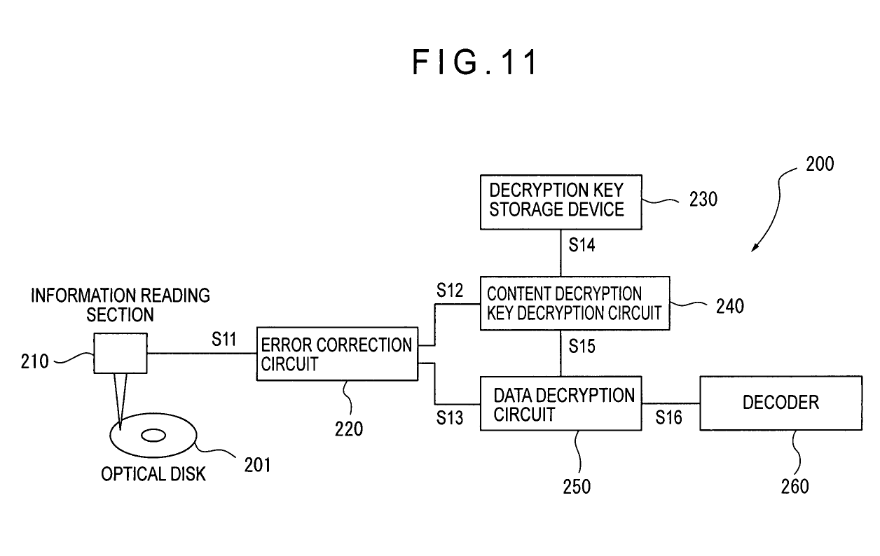

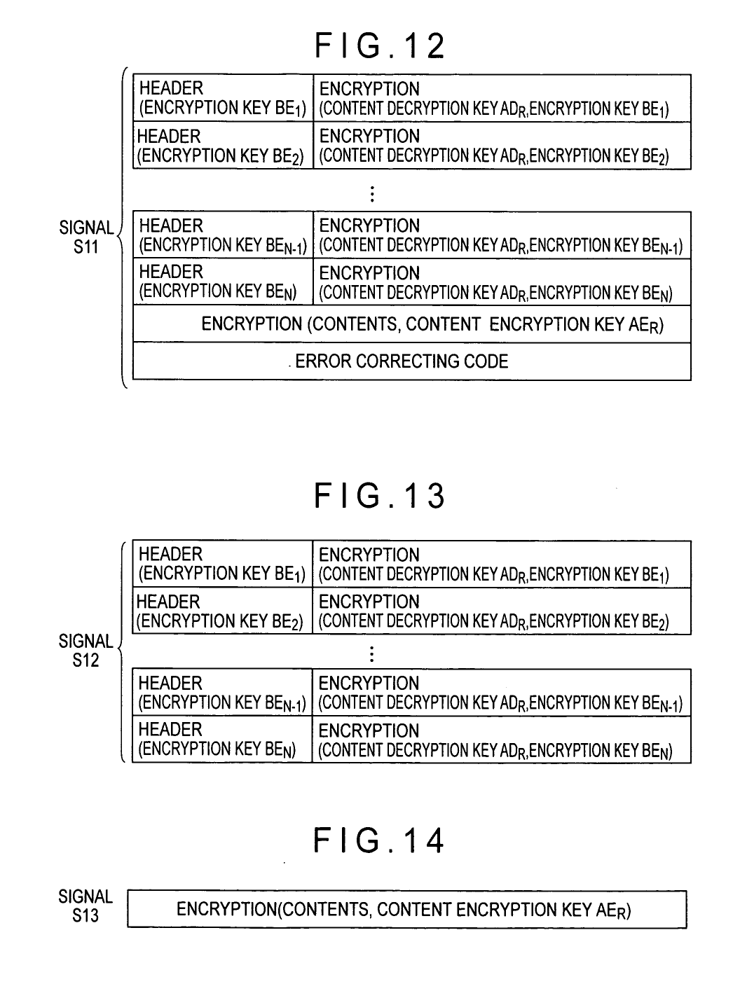

Next, a schematic configuration of the playback device 200, which is an information playback device for playing optical disk as the recording medium recorded with contents, will be described by referring to a block diagram shown in FIG. 11 and data format diagrams shown in FIG. 12 to FIG. 17.

The playback device 200 is provided with an information reading section 210, an error correction circuit 220, a decryption key storage device 230 as a decryption key storing section, a content decryption key decryption circuit 240 as a content decryption key decrypting section, a data decryption circuit 250 as a content decrypting section and a decoder 260 as a content playback section. The playback device 200 plays contents recorded in the optical disk 201 as the recording medium, and outputs the contents on an output equipment such as a display and a speaker.

Here, the optical disk 201 is an optical disk as the recording medium, which is manufactured using the master disk 101 of which data is recorded by the recording device 100 as the original; for example, the optical disk 201 can be a DVD-ROM or a CD-ROM.

Each of the circuits 220, 240, 250, the decryption key storage device 230 and the decoder 260 may be constituted by a dedicated hardware respectively. Or the playback device 200 may be provided with hardware resources such as a central processing unit (CPU) and a main memory, and the function of each section may be achieved as collaboration between the hardware resources and a program, which is installed into the CPU to be executed.

The information reading section 210 is a device such as an optical pick-up, which reads out the information recorded on the optical disk 201 and outputs a signal S11. The signal S11 (S11=Header (encryption key BEᵢ)|Encryption (content decryption key AD_{R}, encryption key BEᵢ)|Encryption (contents, content encryption key AE_{R})|ECC) is the information read out from the optical disk 201 by the information reading section 210, and is identical with the signal S7. That is, as shown in FIG. 12, the signal S11 includes plural content decryption keys AD_{R} encrypted using plural encryption keys BEᵢ, the header information of the respective encryption keys BEᵢ, contents encrypted by the content encryption key AE_{R} and the error correction code ECC.

The error correction circuit 220 is a device, which performs error correction on the input signal S11. The error correction method is, as described above, a well-known technique using the ECC; so the description thereof will be omitted.

The error correction circuit 220 separates the signal after the error correction to two signals; i.e., the signal S12 (S12=Header (encryption key BEᵢ)|Encryption (content decryption key AD_{R}, encryption key BEᵢ)) and the signal S13 (S13=Encryption (contents, content encryption key AE_{R})), and outputs the signals therefrom.

Here, as shown in FIG. 13, the signal S12 is identical with the signal S6. That is, the signal S12 is a collection of the content decryption key AD_{R} encrypted by the encryption key BEᵢ and the header information of the encryption key BEᵢ.

On the other hand, as shown in FIG. 14, the signal S13 is the contents encrypted by the content encryption key AE_{R}, and is identical with the signal S4.

The decryption key storage device 230 is a device which stores plural kinds of decryption keys (decryption key for decryption keys) BD₁, BD₂, . . . ,BDⱼ, . . . ,BD_{M-1} and BD_{M}, which are owned by each of the playback devices 200, and the header information Header (decryption key BD₁), Header (decryption key BD₂), . . . , Header (decryption key BDⱼ), . . . , Header (decryption key BD_{M-1}) and Header (decryption key BD_{M}). In this description, it is assumed that M decryption keys are owned.

The decryption key storage device 230 stores at least one regional decryption key from one or more regional decryption keys, which are allotted to each of the playback regions to which the playback device 200 belongs, and a playback device decryption key allotted to each of the playback devices 200.

Each of the decryption keys BDⱼ stored in the decryption key storage device 230 is arranged so that the relationship of P=Decryption (Encryption (arbitrary data P, encryption key BEᵢ), decryption key BDⱼ) is established between the encryption key BEᵢ and the decryption key BDⱼ.

Also, the values of the headers are predetermined so that the relationship of Header (encryption key BEᵢ)=Header(decryption key BDⱼ) is established between the header added to the encryption key BEᵢ and the header added to the decryption key BDⱼ.

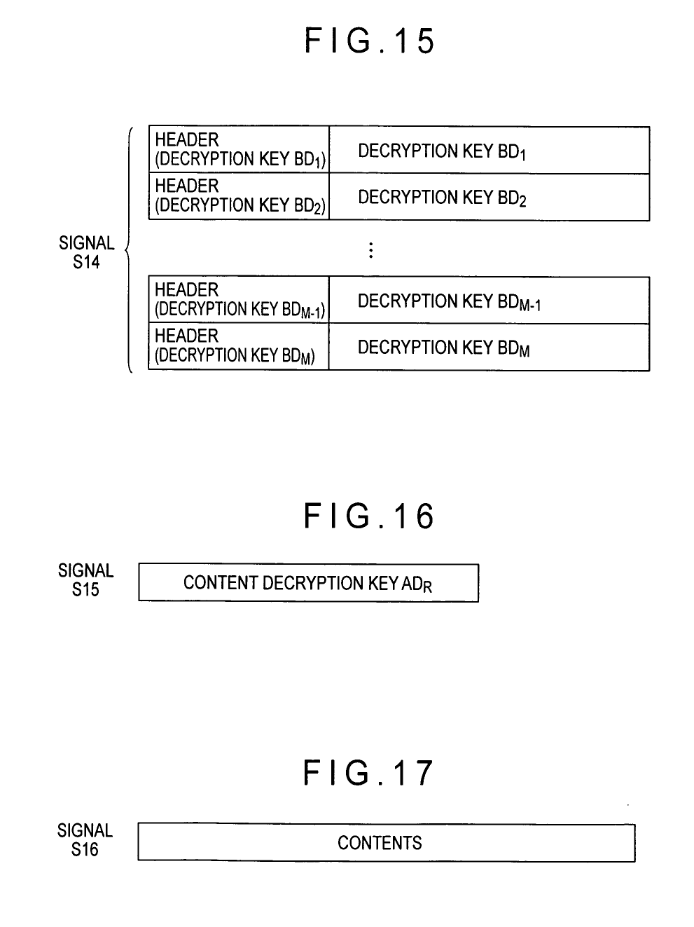

As shown in FIG. 15, the signal S14, which is output from the decryption key storage device 230, is provided with “decryption key BD₁|decryption key BD₂|. . . |decryption key BDⱼ|. . . |decryption key BD_{M-1}|decryption key BD_{M}” and their header information “Header (decryption key BD₁)|Header (decryption key BD₂)|. . . |Header (decryption key BDⱼ)|. . . |Header (decryption key BD_{M-1})|Header (decryption key BDₘ)”.

The content decryption key decryption circuit 240 is a circuit which inputs signals S12 and S14 and determines whether or not the header “Header (encryption key BEᵢ)”, which is read out from the optical disk 201, and the header “Header (decryption key BDⱼ)”, which is owned by the playback device 200, agree with each other, and when determined as agree with each other, decrypts the content decryption key AD_{R} (AD_{R}=Encryption (content decryption key AD_{R}, encryption key BEᵢ)), which is encrypted using the decryption key BDⱼ.

That is, the algorithm for decrypting the content decryption key AD_{R} is expressed as: content decryption key AD_{R}=Decryption (Encryption (content decryption key AR_{R}, encryption key BEᵢ), decryption key BDⱼ).

This processing is carried out on each of the combinations of i and j until a combination of headers which agree with each other is found. When such combination is found and the content decryption key AD_{R} is decrypted, the content decryption key decryption circuit 240 outputs a signal S15 (S15=content decryption key AD_{R}) shown in FIG. 16. When no combinations which agree with each other are found, since the content decryption key decryption circuit 240 cannot output the signal S15, the playback device 200 determines that the optical disk 201, which is presently being read out, cannot be played, and every processing is terminated.

The data decryption circuit 250 is a circuit which inputs the signal S13 and the signal S15, decrypts the signal S13 using the signal S15, and outputs Decryption (Encryption (contents, content encryption key AE_{R}), content decryption key AD_{R})=contents, which is the result thereof, as a signal S16 shown in FIG. 17.

The decoder 260 is a circuit, which decodes the input signal S16 (S16=contents) and plays the same. For example, when the playback device 200 is connected to a TV or a display, the played contents are output on the TV or the like.

### Operation of the Playback Device

Next, the recording operation of contents in the above described playback device 100 will be described.

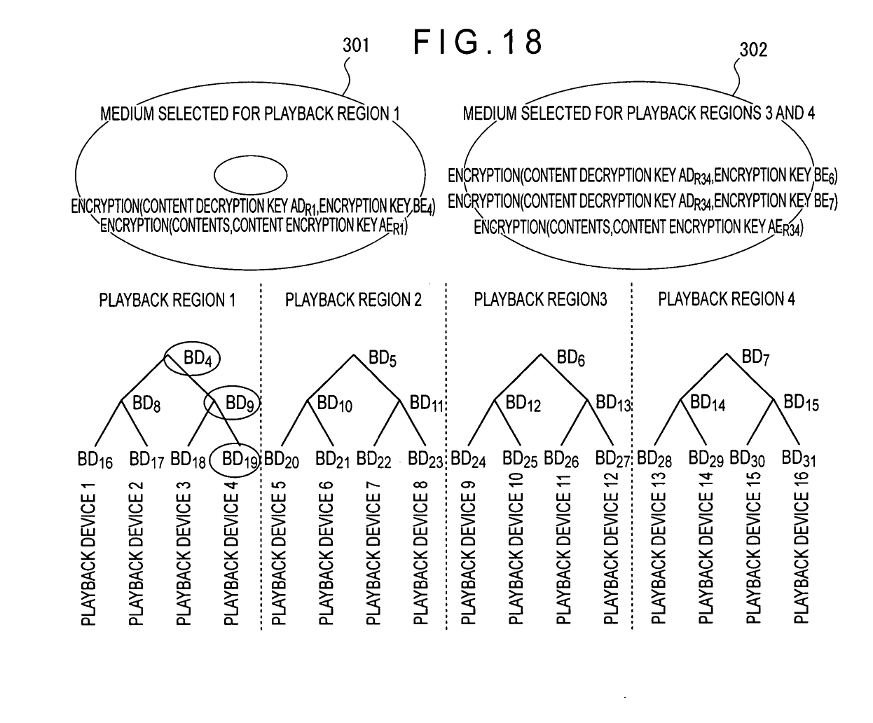

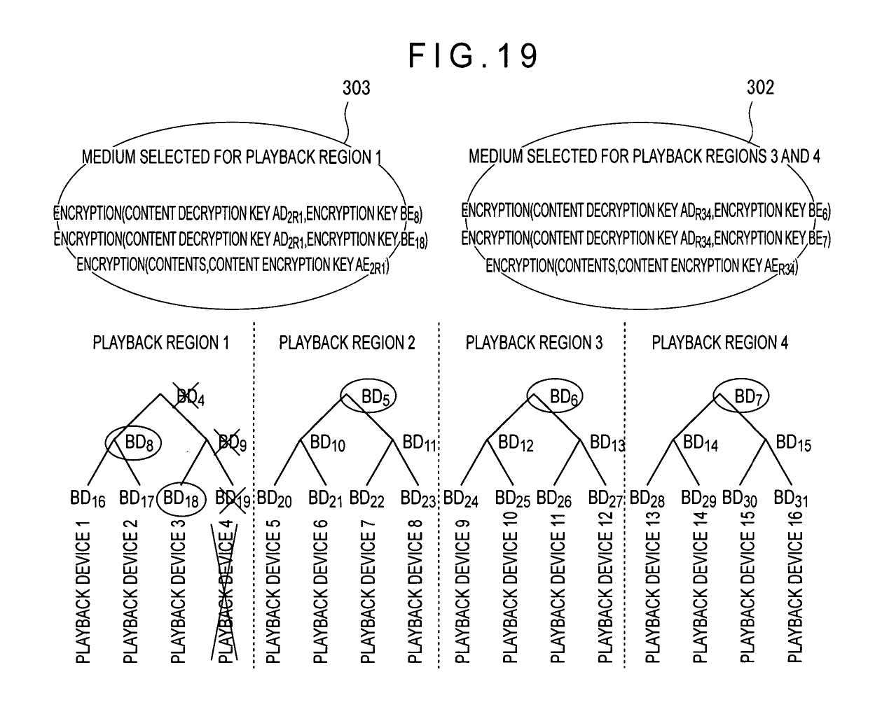

Before describing concrete operation, a key management system in this embodiment, which has a selected region playback managing function of contents, will be described by referring to FIG. 18 and FIG. 19.

### Key Management System with Selected Region Playback Managing Function

In this system, a tree for managing the keys is divided into sub-tees based on playback region, and each of the sub-trees is allotted with one playback region. For example, as shown in FIG. 18, in the case where four playback regions 1-4 are formed, four sub-trees corresponding to each of the playback regions are set up.

Each of the nodes, which includes a root and leaves of each sub-tree, is allotted respectively with an encryption key BEᵢ and a decryption key BDⱼ corresponding thereto. Each of the playback devices is previously provided with decryption keys BDⱼ residing in the path from the leaf, to which the playback device itself is allotted, to the root of the sub-tree.

When the encryption key BEᵢ and the decryption key BDⱼ corresponding thereto are in common (identical with each other) like the secret key method, one key, which is shared between the encryption key BEᵢ and the decryption key BDⱼ, is allotted to each of the nodes. On the other hand, when the encryption key BEᵢ and the decryption key BDⱼ are different from each other like the public-key method, two kinds of keys of the encryption key BEᵢ and the decryption key BDⱼ are allotted to each of the nodes. In FIG. 18 and FIG. 19, on the sub-tree, the decryption key BDⱼ only is indicated but the encryption key BEᵢ is omitted.

Here, the encryption keys BE₄-BE₇ and decryption keys BD₄-BD₇, which are allotted to the root of each sub-tree are common to every playback device included in each of the playback regions. Accordingly, in the initial state that no revoked playback device resides in, the above keys function as regional encryption key and decryption key for identifying the playback regions.

On the other hand, the encryption keys BE₁₆-BE₃₁ and the decryption keys BD₁₆-BD₃₁, which are allotted to the leaves in each sub-trees, are different for each of the playback devices 1-16. Accordingly, the respective keys function as an encryption key and a decryption key of each playback device for identifying the respective playback device.

Also, since each of the encryption keys BE₁₆-BE₃₁ and the decryption keys BD₁₆-BD₃₁, and each of the encryption keys BE₈-BE₁₅ and the decryption keys BD₈-BD₁₅ residing in the nodes between the root and the leaves are the keys are all unique respectively having no equivalent to each other, if the keys are identified, the playback regions corresponding to the keys are also identified. Therefore, each of the keys functions also as the encryption key and the decryption key of the regions. In other words, any type of regional encryption keys and regional decryption keys may be employed if the playback regions corresponding thereto can be identified based on the keys.

In the example shown in FIG. 18, a binary sub-tree structure is employed as the tree structure. The total number of the playback devices is 16; the number of the playback regions is 4; the number of the playback devices belonging to each of the playback regions is 4; and the number of the decryption keys BDⱼ owned by each playback device is 3. For example, the playback device 4 belonging to the playback region 1 has three decryption keys of BD₄, BD₉, and BD₁₉, which are marked with circles.

Each of these nodes is allotted with different keys. And it is arranged so that, among the playback devices belonging to the same playback region (for example, playback devices 1 and 2), common decryption keys (for example, decryption key BD₄, and BD₈) are provided; but, among the playback devices belonging to the playback regions different from each other, (for example, playback devices 1 and 5), common decryption keys are not provided.

Assuming that the total number of the playback devices is “N”, the number of the playback regions is “R”, and the same number of the playback devices are included in each of the playback regions, then the number of the decryption keys BDⱼ owned by the playback devices is log₂(N/R)+1.

For example, when creating a medium 301, which can be played in the playback region 1 only, recorded in the medium 301 are the contents (the contents=Encryption (contents, content encryption key AE_{R1})) encrypted by the content encryption key AE_{R1}, and the content decryption key AD_{R1} (AD_{R1}=Encryption (content decryption key AD_{R1}, encryption key BE₄)) encrypted by the encryption key BE₄ residing at the root of the playback region 1.

On the other hand, when creating a medium 302, which can be played by the playback devices 3 and 4 only, recorded in the medium 302 are the contents (the contents=Encryption (contents, content encryption key AE_{R34})) encrypted by the content encryption key AE_{R34}, and the content decryption key AD_{R34} (AR_{R34}=Encryption (content decryption key AD_{R34}, encryption key BE₆)|Encryption (content decryption key AD_{R34}, encryption key BE₇)) encrypted by the encryption keys BE₆ and BE₇ residing in the roots of the playback regions 3 and 4.

A pair of the content encryption key and the content decryption key is allotted to each of the combinations of arbitrary playback regions. That is, when a medium is limited to the playback region 1 only, the medium is allotted with the content encryption key AE_{R1} and the content decryption key AD_{R1} for the playback region 1. On the other hand, when a medium is limited to the playback regions 3 and 4 only, the medium is allotted with the content encryption key AE_{R34} and the content decryption key AD_{R34} for the combination of the playback regions 3 and 4.

Likewise, according to each of the combinations of playback regions such as playback region 2 only, 3 only, 4 only, or playback regions 1, 2, 3 and 4, one of the pairs of the content encryption key and the content decryption key is allotted thereto respectively.

Here, when revoking a specific (plural or a single) playback device(s), which belong(s) to a playback region, a revocation processing is made only on a sub-tree, to which the playback device(s) to be revoked is/are included. For example, when revoking playback with the playback device 4, as shown in FIG. 19, a sub-tree, which covers the playback devices 1-3 excluding the playback device 4 is formed, and content decryption key AD_{2R1}, which is newly set up (renewed), is encrypted using encryption keys BE₈ and BE₁₈ on the sub-tree, and recorded on the new medium 303. And the contents are encrypted by a content encryption key AE_{2R1} corresponding to the content decryption key AD_{2R1}, and recorded on the new medium 303.

Owing to this arrangement, since the playback device 4 do not have any decryption key corresponding to the encryption keys BE₈ and BE₁₈ of the medium 303, the playback device 4 cannot decrypt the content decryption key AD_{2R1} of the medium 303, and therefore can not decrypt and play the contents. Also, even when any one of the decryption keys BD₄, BD₉ and BD₁₉ is leaked out, the medium 303 cannot be played by the leaked key. Accordingly, the copyright of content is protected.

In this case, when the content decryption key AD_{2R1} and the content encryption key AE_{2R1} are changed into the keys different from those of the old medium 301, even when the content decryption key AD_{R1} is leaked out, the new medium 303 can not be played.

That is, when a playback device to be revoked is newly found, the content decryption key and the content encryption key are set up after being changed to new keys. As a result, different content decryption key and content encryption key are used depending on the combination of the playback devices, which are permitted to play (not revoked) in an region where content playback is permitted. Accordingly, when the playback device 1 is also revoked, in addition to the playback device 4, further new content decryption key AD_{3R1} and content encryption key AE_{3R1} are used. In this embodiment, at the right side of the suffix R in the symbol of each key, a number of playback region is given, and at the left side thereof, a version of the key is given.

This method has the following characteristics; i.e., based on the region where playback is permitted, or in accordance with the combination of the regions, different content decryption key AD_{R} and the content encryption key AE_{R} are used; and further, the sub-trees for managing the decryption keys BDⱼ and corresponding encryption keys BEᵢ owned by the playback devices are independent from each other based on playback region. Accordingly, even when a content decryption key AD_{R} of a particular playback region or decryption key BDⱼ owned by the playback device belonging to the playback region is leaked out, only the mediums, which are permitted playback in the playback regions, are subjected to the influence therefrom, but no influence is rendered to the media, which are permitted playback in the playback regions other than the above.

In the example shown in FIG. 18 and FIG. 19, the medium influenced by the leakage of the key owned by the playback device 4 is the medium 301 only that permits playback in the playback regions including the playback region 1.

Accordingly, the medium 302 limited to the playback regions 3 and 4 has no relationship with the revocation of the playback device 4; thus, no alteration is required.

In this embodiment, decryption keys BDⱼ different from each other are allotted to each of the playback devices. Therefore, the revocation of each playback device can be controlled only by changing the encryption key BEᵢ recorded in the medium side; each of the playback devices 1-16 has no relationship with the leakage of its own key. Accordingly, no change is required on the decryption key BDⱼ of its own.

### Content Recording Procedure in the Recording Device

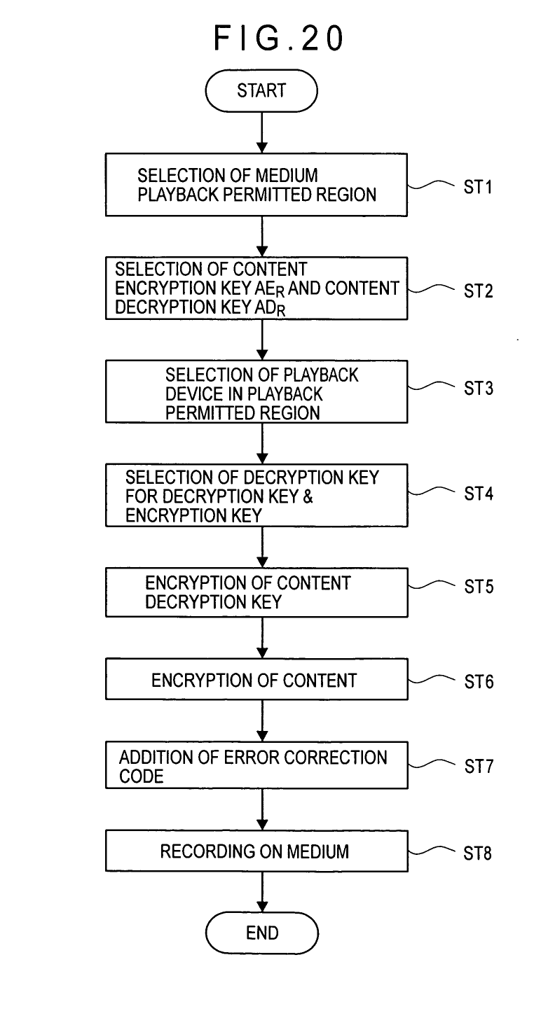

Next, the content recording procedures in the recording device 100 of the embodiment will be described by referring to the flowchart in FIG. 20.

When recording contents on the master disk 101, first of all, the recording device 100 prompts to select the regions where playback of the medium is permitted (step ST1). This selection is ordinarily carried out by a content provider (copyright holder) or the like, who creates the medium by inputting instructions.

When the regions where playback of the medium is permitted are selected and the recording device 100 obtains the selection information, the content encryption key inputting circuit 130 and the content decryption key inputting circuit 120 selects (choices) the content encryption key AE_{R} and the content decryption key AD_{R} corresponding to the combination of regions which are permitted to play (step ST2). For example, in FIG. 18, when the playback regions 3 and 4 are selected, the content encryption keys AE_{R34} and the content decryption keys AD_{R34} corresponding to the combination are selected.

These selected keys are output to the data encryption circuit 140 and the content decryption key encryption circuit 160 as the signals S3 and S4.

Next, the key encryption key inputting circuit 150 prompts to select the playback devices, which are permitted playback of the objective medium in the regions where playback is permitted (step ST3). Ordinarily, this selection is also carried out by the content provider. It may be arranged so that, for example, using a display device (output device) such as a display provided to the playback device 100 and an input device such as keyboard, instructions are given to select every playback device or a particular playback device in the regions where playback is permitted. Further, it may be arranged so that, by storing the information for identifying a playback device, of which decryption key BDⱼ has leaked out, and preparing a selection including the playback devices excluding the playback device of which decryption key BDⱼ has leaked out, and the user can easily select the playback devices excluding that playback device.

When the playback regions and the playback devices are selected, the key encryption key inputting circuit 150 selects the decryption key BDⱼ and creates a collection of the predetermined decryption keys BDⱼ (step ST4). Specifically, in the collection of decryption keys BDⱼ, in which every selected playback device has at least one decryption key BDⱼ in the collection; and playback devices, which are not selected (playback is not permitted), do not have any decryption key BDⱼ in the collection, a collection in which the number of the keys is the smallest, is selected.

Also, accompanying the selection of the decryption key BD_{j,} the key encryption key inputting circuit 150 selects the encryption key BEᵢ corresponding to the selected encryption key BDⱼ (step ST4).

The key encryption key inputting circuit 150 outputs the selected encryption key BEᵢ to the content decryption key encryption circuit 160 as the signal S5.

Receiving the signals S2 and S5, the content decryption key encryption circuit 160 encrypts signal S2 (S2=content decryption keys AD_{R}) using the signal S5 (S5=every selected encryption key BEᵢ), and outputs the signal S6 comprised of the encrypted data (the encrypted data=Encryption (content decryption key AD_{R}, encryption key BEᵢ)) and the header information of each of the encryption keys BEᵢ to the error correction circuit 170 (step ST5).

Also, upon receiving the signal S1 and the signal S3, the data encryption circuit 140 encrypts the signal S1 (S1=contents) using the signal S3 (S3=content encryption key AE_{R}), and outputs the encrypted data (the encrypted data=Encryption (contents, content encryption key AE_{R})) to the error correction circuit 170 as the signal S4 (step ST6).

Upon receiving the signals S4 and S6, the error correction circuit 170 combines the signals S4 and S6 with each other and adds the error correction code thereto, and outputs the signals to the media recording section 180 as the signal S7 (step ST7).

The media recording section 180 records the received signal S7 on the master disk 101 as the recording medium (step ST8).

Owing to the above-described steps ST1-ST8, a medium (or a master disk), which can be played in the predetermined playback regions and with predetermined playback devices, is manufactured.

### Content Playback Procedure in Playback Device

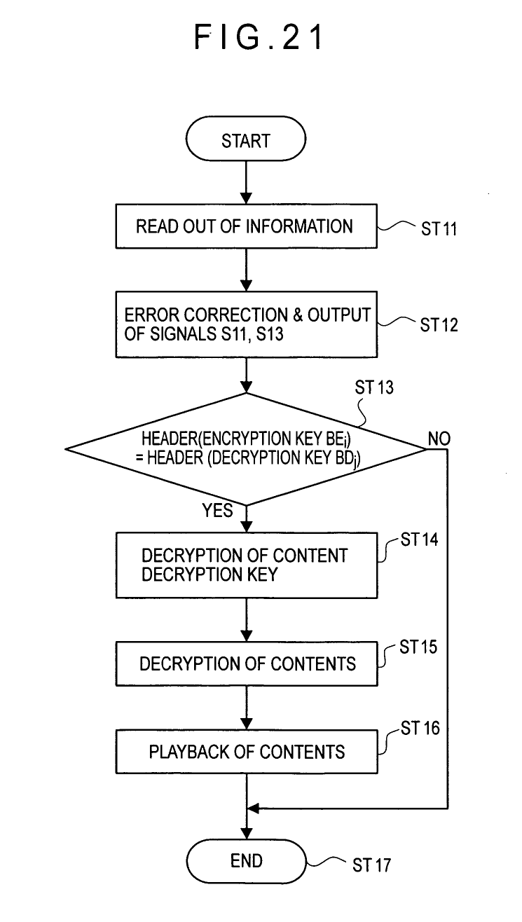

Next, the procedures of playing the medium, which is created by the recording device 100, using the playback device 200, will be described by referring to the flowchart in FIG. 21.

When the optical disk 201 as the recording medium is set up, the playback device 200 reads out the information of the optical disk 201 using the information reading section 210, and outputs the information to the error correction circuit 220 as the signal S11 (step ST11).

Upon receiving the signal S11, the error correction circuit 220 performs the error correction processing, and outputs the signal S12 (S12=Header (encryption key BEᵢ)|Encryption (content decryption key AD_{R}, encryption key BEᵢ)) and the signal S13 (S13=Encryption (contents, content encryption key AE_{R})) to the content decryption key decryption circuit 240 and the data decryption circuit 250 respectively (step ST12).

The content decryption key decryption circuit 240 compares the Header (encryption key BEᵢ) of the signal S12 and the Header (decryption key BDⱼ) of M decryption keys BDⱼ stored in the decryption key storage device 230, and checks whether or not there are any Headers which agree with each other (step ST13).

Here, in the case there are Headers which agree with each other (i.e., in case of Yes), the content decryption key decryption circuit 240 decrypts the content decryption key AD_{R} using the decryption key BDⱼ stored in the decryption key storage device 230, and outputs the key to the data decryption circuit 250 as the signal S15 (step ST14).

Upon receiving the signal S15, the data decryption circuit 250 decrypts the contents using the content decryption key AD_{R,} and outputs the contents to the decoder 260 as the signal S16 (step ST15).

Upon receiving the signal S16, the decoder 260 plays (decodes) the contents (step ST16). When the playback of the contents completes, the playback processing by the playback device 200 is also terminated (step ST17).

On the other hand, in step ST13, in the case there are no Headers which agree with each other (i.e., in case of No), since the playback by the playback device 200 is not permitted, the optical disk 201 terminates the processing without playing the contents (step ST17).

### Effect of the First Embodiment

According to the first embodiment, the contents are encrypted using the content encryption keys AE_{R}, which are different for each of the combinations of regions where playback is permitted, and the content decryption key AD_{R} for decrypting the above is encrypted by plural encryption keys BEᵢ. Accordingly, by encrypting the content decryption key AD_{R} using an encryption key BEᵢ corresponding to a decryption key BDⱼ owned by a playback device only that is permitted playback and recording the key in the recording medium, the playback devices permitted to play the contents can be controlled.

And these encryption keys BEᵢ and decryption keys BDⱼ are set up so as to be different for each of the preset regions. Accordingly, by only using an encryption key BEᵢ that is set up in the regions where playback is permitted, the limited regional playback control can be carried out without using any region code.

Further, by setting up the encryption key BEᵢ appropriately, even to the playback devices residing in a region where playback is permitted, the playback can be controlled individually.

Owing to this arrangement, compared to the conventional method, which performs the playback management using the region code only, much higher security can be achieved from the point of view of copyright protection of the contents.

Furthermore, the content decryption keys AD_{R} and the content encryption keys AE_{R} different for each of the regions or the combination of the regions where playback is permitted are used, and the sub-tees, which manage the decryption keys BDⱼ owned by the playback devices and the corresponding encryption keys BEᵢ, are independent from each other within each of the playback regions. Accordingly, even when a content decryption key AD_{R} in a particular playback region or a decryption key BDⱼ owned by a playback device belonging to the playback region is leaked out, no influence is rendered to the media or the playback devices, which are permitted the playback in other playback regions. Owing to this arrangement, compared to the conventional case set forth in the documents 1 and 2, where a tree structure, which is not divided based on playback region, is employed, and the content encryption keys and the content decryption keys do not differ with the region where playback is permitted, preventive measures against the leakage of the key can be taken extremely simply.

By using two different kinds of encryption keys such as the content encryption key AE_{R} and the encryption key BEᵢ, as the protective measures against the leakage of the content decryption keys AD_{R}, the content decryption keys AD_{R} can be renewed without requiring any changes on the decryption keys or the like at the playback device side.

Accordingly, even when content decryption key AD_{R} is leaked out, the protective measures is made by just creating a new medium using a new content decryption key AD_{2R}, and no alteration on the decryption key BDⱼ is required at the playback device side. Owing to this arrangement, compared to the case where the alteration is required also at the playback device side, the corrective measures against the leakage of the content decryption keys AD_{R} can be readily taken; thus, the effectiveness of the copyright protection can be increased.

Also, even when a decryption key BDⱼ of a playback device is leaked out, by changing the record at the medium side, in every playback device in the objective playback regions, only the decryption key BDⱼ owned by a particular playback device can be revoked. Accordingly, the decryption key BDⱼ enabling the playback can be changed without requiring any alteration at the playback device side.

As described above, the playback device at the user side requires no alteration, and the preventive measures can be taken at the content supplier side only. Accordingly, the contents can be protected much effectively and swiftly.

According to the embodiment, a selected playback region control is achieved with the key management system having a modified tree structure without using any region code. In a system which uses the key management system employing the tree structure for the purpose of copy protection, when the selected playback region control method of the present invention is added thereto, there is no devices that require extra addition both at the medium side and the playback device side. Accordingly, the control method of the present invention can be introduced thereto extremely easily and at low cost.

That is, when using the copy protection system with the key management system having the tree structure and the selected playback region control using a flag such as region code together, in addition to the key information, the flag has to be added to the medium side, and in addition to the processing devices of the key information, a device for identifying the flag has to be provided to the playback device side. Compared to the above, according to the embodiment, at the medium side, only the key information is recorded, and the flag does not have to be added; and the playback device side also, the deice to process the flag does not have to be provided thereto. Accordingly, the circuits and the like can be configured simply; and thus, the cost also can be reduced. Additionally, the selected playback region control like the case where the conventional flag is used can be achieved as well as the copy protection system corresponding to the key management system can be achieved. Thus, the copyright protection function equivalent to the conventional method or the higher can be achieved.

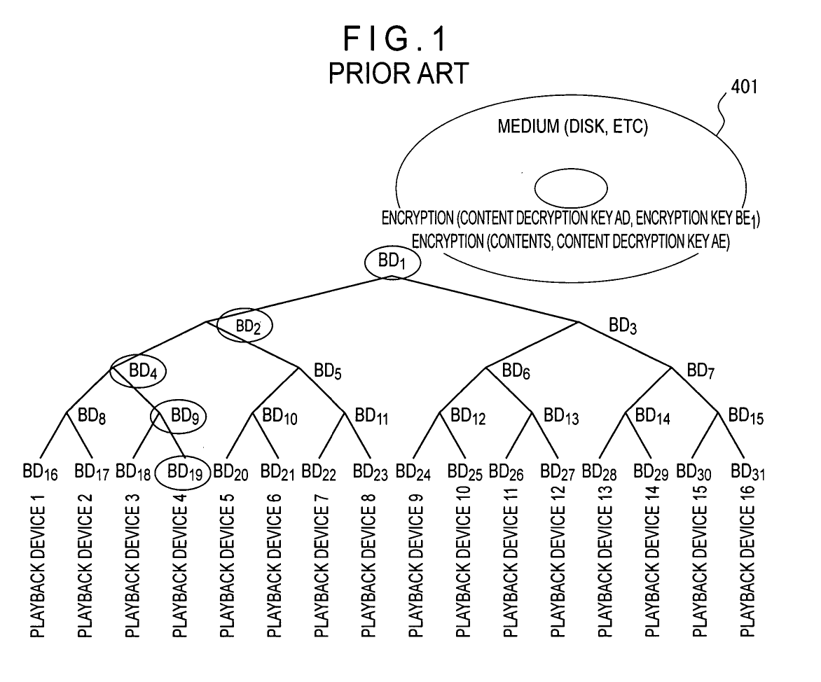

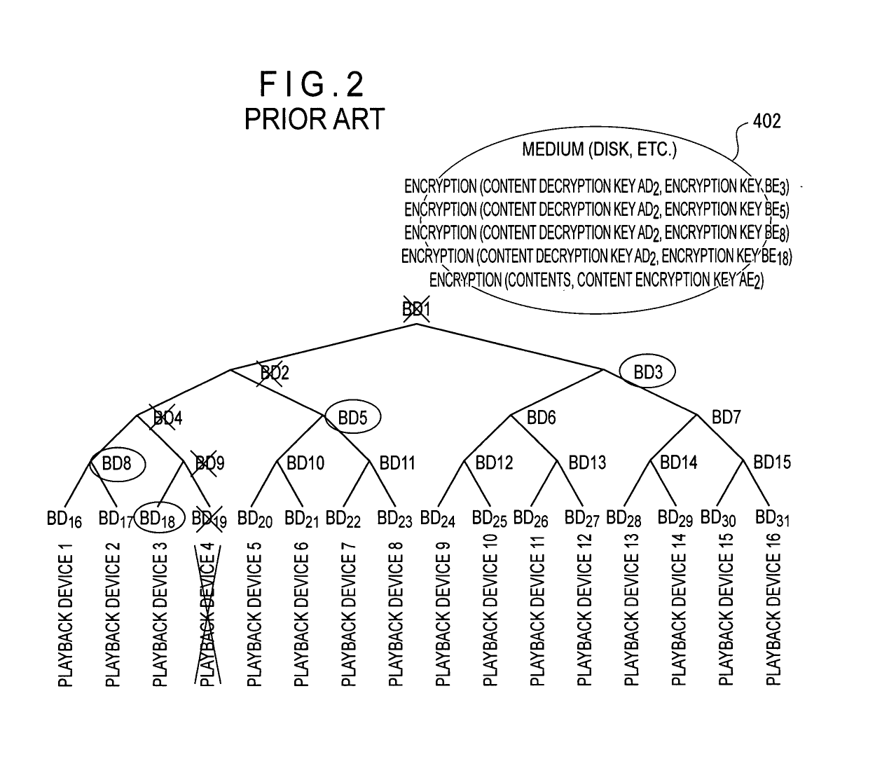

Since the tree structure is divided based on the preset playback region, the number of the decryption keys BD_{j,} which are previously owned by the playback device side, can be reduced. That is, in the conventional key management structure shown in FIG. 1 and FIG. 2, when the number of the playback devices is N, each of the playback devices has the decryption keys of log₂N+1. On the other hand, according to the embodiment, when the number of the playback regions is R, the number of the decryption keys BDⱼ owned by each of the playback devices can be reduced to log₂(N/R)+1. Accordingly, the storage capacity of the decryption key storage device 230 in the playback device 200 can be reduced; thus, the cost for that also can be reduced.

Depending on the number of the playback regions where playback is permitted at the same time, compared to the conventional method, the upper limit of the data amount of the encrypted content decryption key AD_{R} (Encryption (content decryption key AD_{R}, encryption key BEᵢ)) to be recorded in the medium can be reduced.

That is, when the conventional complete sub-tree method is used as shown in FIG. 1 and FIG. 2, the upper limit of the number of the encrypted content decryption keys AD_{R} (Encryption (content decryption key AD_{R}, encryption key BEᵢ)) to be recorded in a medium is, assuming that the number of the playback devices to be revoked is “r”, and the total number of the playback devices is “N”, expressed as rlog₂(N/r). According to the method of the embodiment, the complete sub-tree methods are used independently from each other based on the playback regions. When the number of the playback region where playback is permitted at the same time is one, it is understood that the number of the playback devices is reduced from “N” to N/R (R is total number of the playback regions). Owing to this, the upper limit of the number of the content decryption key AD_{R} to be recorded in the medium is resulted in rlog₂(N/(Rr)). Thus, compared to the conventional method, the number can be considerably reduced.

On the other hand, when there are plural playback regions where playback is permitted at the same time, in the initial state (a state that playback device is not revoked in the objective playback regions), the content decryption keys AD_{R} have to be encrypted using the encryption key BEᵢ allotted to the every root of the objective playback regions, and recorded in the medium. Due to this overhead, the upper limit of the number of the content decryption keys AD_{R} recorded in each of the media is not always reduced. However, generally, compared to the overhead due to the increase of the number of the playback regions where playback is permitted at the same time, the overhead due to the increase of number of the playback devices to be revoked is much larger. Accordingly, in the ordinary operation, the increase can be almost negligible. The actual number of the content decryption keys AD_{R} can be reduced.

Assuming that the data amount of the encrypted content decryption key AD_{R} recorded in the medium is constant, the upper limit of the playback device, which can be revoked, can be increased. Accordingly, a large number of playback devices can be revoked.

Since the medium stores header information also indicating the kind of the encryption key for decryption key, by referring to the header information, each of the playback devices can determine easily and swiftly whether or not the decryption is possible using the decryption key for decryption key owned by each of the playback devices. A higher decryption processing can be achieved.

### Second Embodiment

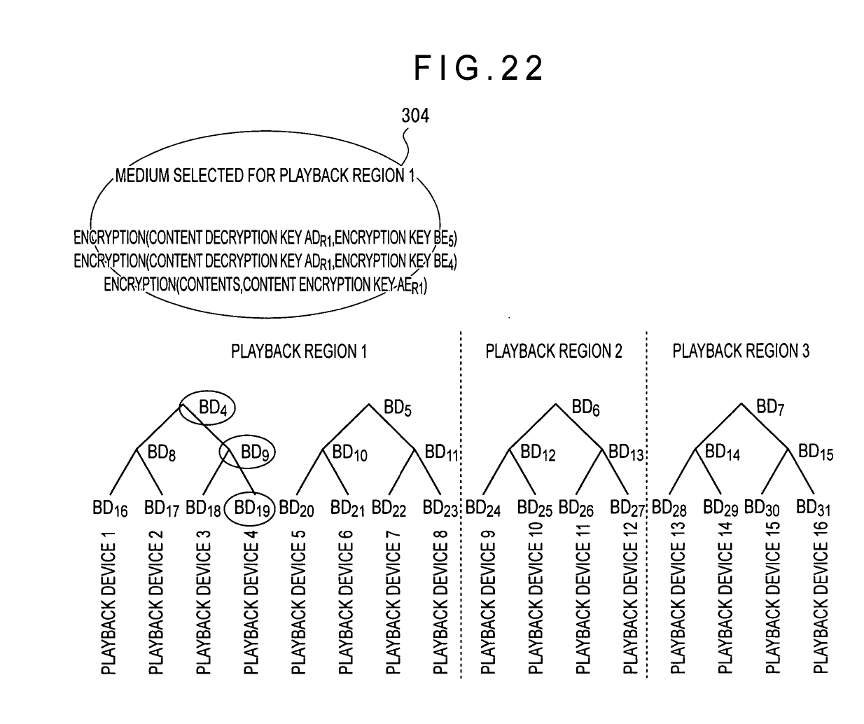

Next, a second embodiment of the present invention will be described by referring to FIG. 22.

The second embodiment is different from the first embodiment in the only point that plural tree structures are formed in one region. Other configurations such as the recording device 100 and the playback device 200 are identical with those in the first embodiment. Therefore, the descriptions about these configurations will be omitted, and the key management system only will be described.

In this embodiment, the playback region 1 is formed with two tree structures. Like the first embodiment, each of the nodes including the root and the leaves of each sub-tree is allotted with one encryption key BEᵢ and one decryption key BDⱼ respectively. Each of the playback devices is previously provided with the decryption key BDⱼ residing on a path from the leaf to which the playback device itself is allotted to the root of the sub-tree.

Like the first embodiment, each of the encryption key BEᵢ and the decryption key BDⱼ is a unique key respectively, which is different from the encryption key BEᵢ and the decryption key BDⱼ allotted to each of the nodes, and it is arranged so that no identical key is included among the encryption keys BEᵢ and the decryption keys BDⱼ. Accordingly, the keys provided to each of the nodes of the two tree structures in the playback region 1 are also the keys different from each other.

Therefore, the regional encryption key and the decryption key in the playback region 1 include at least two kinds of keys of the encryption key BE₄, BE₅ and the decryption key BD₄, BD₅ respectively allotted to the root of the two sub-trees in the playback region 1. Accordingly, the medium 304 for the playback region 1 is recorded with the content decryption key AD_{R1} encrypted by the encryption keys BE₄ and BE₅.

As for the allotting method of the plural tree structures in the playback region 1, in the case where, for example, each of the playback regions are set up in a range corresponding to the present region code, an appropriate method may be set up when carrying out the embodiment in the following manner, i.e., the region in a region code may be set up more minutely or on the manufacturer basis of the playback device, etc.

In the playback region 1, two sub-trees are provided. However, three or more sub-trees may be provided. In the other playback regions 2-4 also, two or more sub-trees may be provided. In other words, it is acceptable when each of the playback regions 1-4 is provided with one or more sub-trees (tree structures) to manage the keys.

### Effect of the Second Embodiment

In the second embodiment also as described above, the same effect as that in the first embodiment can be obtained.

Further, as the playback region 1, by providing plural tree structures (sub-trees) in one playback region, even when the number of the playback devices disposed in the playback region is large, it is possible to reduce the number of layers of the tree structure. Accordingly, the key management can be carried out easily. Particularly, in one playback region 1, by dividing the sub-tree based on, for example, country, prefectural region, or based on the manufacturer of the playback devices or the like, the key management can be carried out easily. Accordingly, a user-friendly key management system can be provided.

### Third Embodiment

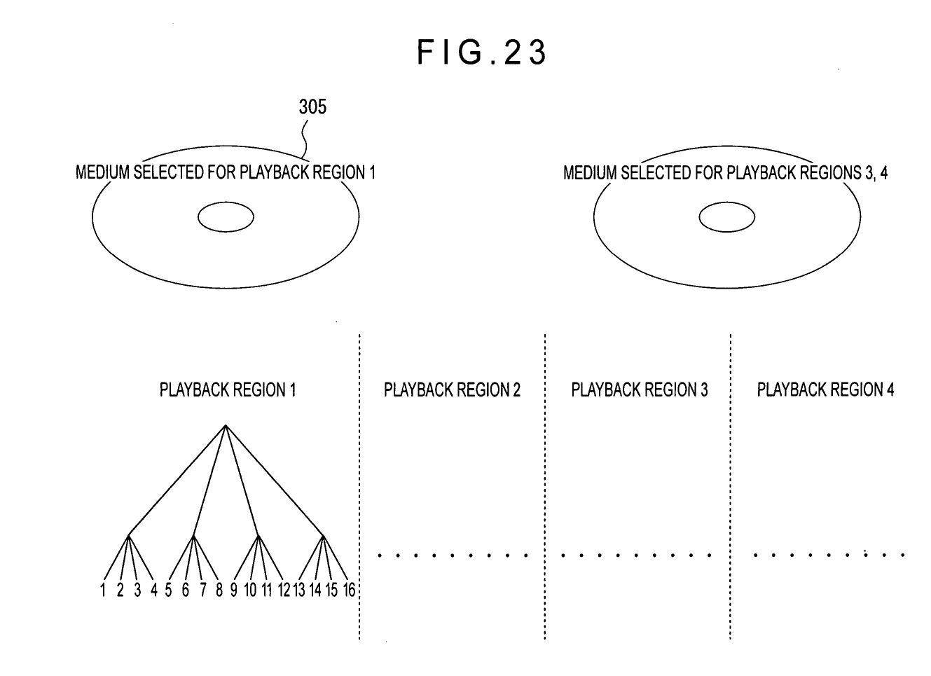

Next, a third embodiment of the present invention will be described by referring to FIG. 23 to FIG. 25.

The third embodiment is different from the first embodiment in the key management system. Other configurations such as the recording device 100 are identical with those in the first embodiment. Therefore, descriptions about these configurations will be omitted, and the key management system only will be described.

The key management system of this embodiment is an application of the tree pattern division system set forth in the document 2. As described in the document 2, the tree pattern division system allots a key to each of the nodes in each layer in which the node in the tree structure is positioned in accordance with node revocation pattern in the layer, which is lower by one layer than the node.

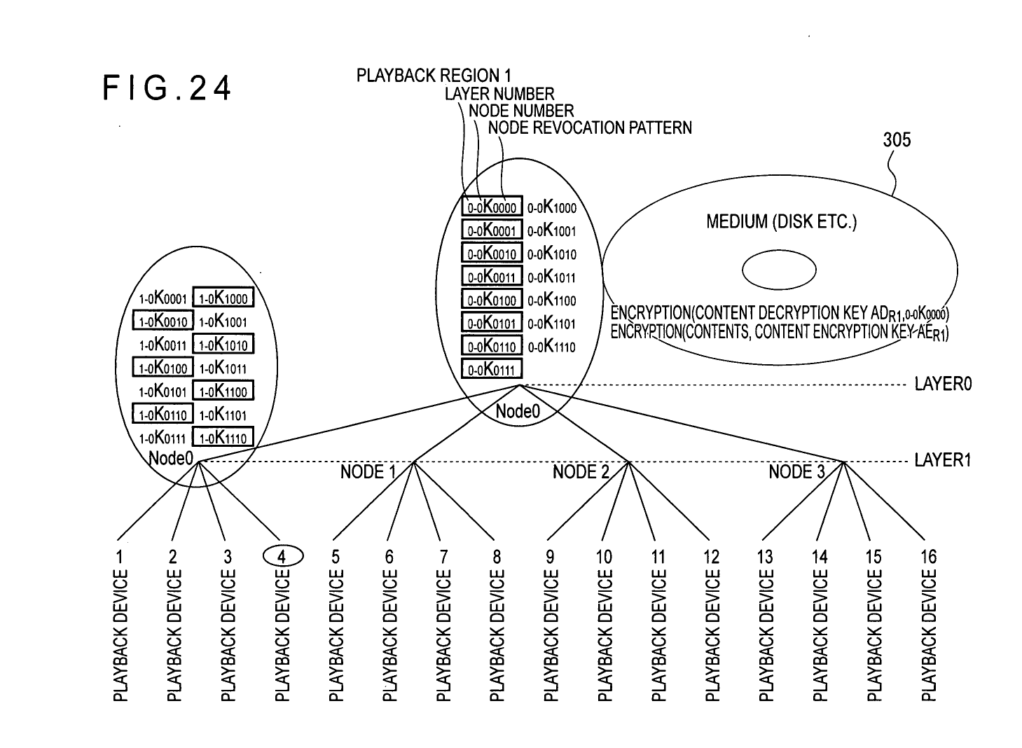

That is to say, as show in FIG. 23, and FIG. 24, at the root (layer 0) of each playback region, a key “₀₋₀K₀₀₀₀₋₀₋₀K₁₁₁₀” corresponding to the pattern for invalidating each node (node 0-3) in the lower layer (layer 1) is set up. It should be noted that, as shown in FIG. 24, a number at the left side of “K” indicates “layer number-relative node number”, and a number of four figures at the right side indicates “node revocation pattern”. In the node revocation pattern, each figure corresponds to each node 0-3; and the figure corresponding to a node to be revoked is indicated by “1”. In this embodiment, since a 4-ary tree structure is employed, the node revocation pattern is also 4-figure (4-bit). In the case of 3-ary tree structure, the numeral is expressed by 3-figure (3-bit). Incidentally, “₀₋₀K₁₁₁₁” indicates a case where every node is revoked, and in this case, since it is not necessary to set up the key for playback, the key therefore is not provided.

By recursively allotting different keys to these revocation patterns in each node of each layer, the keys corresponding to each of the revocation patterns are allotted In the layers lower than the layer 1, the key, which makes every node effective, is expressed by “₁₋₀K₀₀₀₀” or the like. However, to make every node effective, since it is achieved by making the nodes in the layer 1 effective using the upper layer, such key is not provided. Also, because of the same reason as the case of the root, the key, which revokes every node, is not provided.

Each of the playback devices has a key corresponding to a pattern, which causes the playback device itself to be effective, i.e., not be revoked. For example, in FIG. 24, the playback device 4 has the following 15 keys (in FIG. 24, keys marked with thick frame). That is, in the keys of the layer 0, the keys of “₀₋₀K_{0***}” which causes the node 0 in the layer 1, to which the playback device 4 itself belongs, to be effective; i.e., 8 keys (in FIG. 24, keys marked with thick frame) of witch the left end figure in the pattern of 4-figure (the figure corresponding to the node 0 in the layer 1) is “0” indicating “effective”; and in the keys set up in the node 0 of the layer 1, the key of “₁₋₀K_{***0}” which causes the playback device 4 to be effective; i.e., 7 keys (in FIG. 24, keys marked with thick frame) of which the right end figure in the 4-figure pattern is “0”.

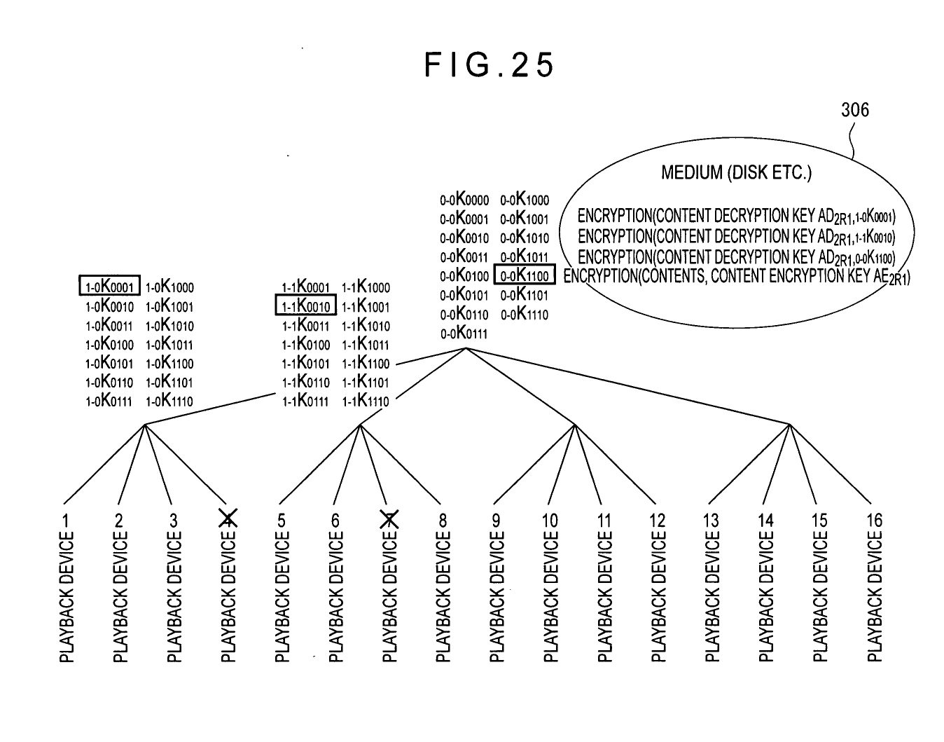

In the tree pattern division system, which is set up as described above, when revoking a playback device, the key of a pattern, which revokes the playback device, is selected, and the decryption key is encrypted using the key. For example, as shown in FIG. 25, when revoking the playback devices 4 and 7, from the layer 0, the key “₀₋₀K₁₁₀₀” corresponding to the pattern, which causes the playback devices 9-16 only to be effective, is selected; in the layer 1, the keys “₁₋₀K₀₀₀₁” and “₁₋₁K₀₀₁₀” corresponding to the pattern which revokes the playback devices 4 and 7 in the nodes 0 and 1, are selected.

When the content decryption key AD is encrypted using these keys and recorded in the medium, since the playback device 9-16 is provided with the decryption key BD corresponding to the key “₀₋₀K₁₁₀₀”, the content decryption key AD can be decrypted using the key BD; thus, the contents can be decrypted. Also, since the playback devices 1-3, 5, 6 and 8 are revoked with respect to the key “₀₋₀K₁₁₀₀”, the contents cannot be decrypted. However, since they are provided with the decryption key BD corresponding to the keys “₁₋₀K₀₀₀₁” and “₁₋₁K₀₀₁₀”, the content decryption key AD can be decrypted using the key BD owned by them; thus, the contents can be decrypt.

As shown in FIG. 23, in this embodiment, the tree structures (sub-trees) as described above are provided independently based on playback region, and the keys corresponding to each of the patterns are unique keys respectively. Accordingly, the playback regions also can be identified based on any of the keys. Accordingly, each of these keys functions as the regional encryption key and the decryption key.

Like the second embodiment, each of the playback regions may be provided with two or more tree structures (sub-trees).

### Effect of the Third Embodiment

In the third embodiment also, content decryption keys AD and content encryption keys AE, which are different for each of the regions or combination of the regions where playback is permitted, are used; and the decryption keys owned by the playback devices and the sub-trees for managing the corresponding encryption keys are independent from each other depending on the playback region. Even when a content decryption key AD of a particular playback region or a decryption key owned by a playback device belonging to the playback region is leaked out, the media or the playback devices, which are permitted playback in other playback regions are subjected to no influence. Thus, the same working as the first and second embodiments is obtained.

Further, the tree pattern division system is employed as the key management system. Therefore, when revoking a playback device, compared to the above embodiments, it is possible to prevent the amount of the keys to be recorded on the medium side from increasing. That is, when revoking, in each node from the playback device to be revoked to the root, only one key corresponding to pattern is selected. Therefore, even when the number of the playback devices to be revoked is large, it is possible to prevent the number of the keys to be recorded on the medium from increasing. Accordingly, the region for recording the keys can be made smaller, and the recording amount of the contents can be made larger.

### Fourth Embodiment

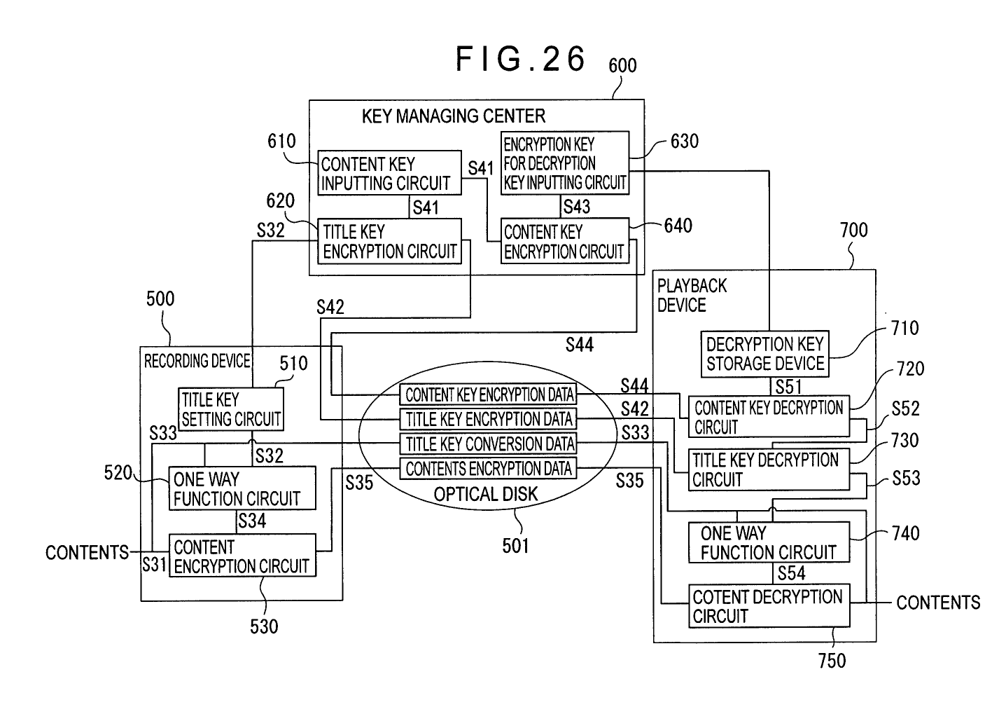

Next, a fourth embodiment of the present invention will be described by referring to FIG. 26.

In the above-described embodiments, the content data are directly encrypted using the content encryption key, and the encrypted data are directly decrypted using the content decryption key. In the record playback system of the fourth embodiment, the content data are encrypted indirectly using the content encryption key, and the encrypted data are decrypted indirectly using the content decryption key.

In this embodiment, the playback device 500 comprises a title key setting circuit 510 for setting up and outputting title key S32, which is set up for every title of the contents S31, a one-way function circuit 520 and a content encryption circuit 530. The one-way function circuit 520 is input with data S33, which is a part of the contents S31 and the title key S32, and outputs the value (data) to encrypt the content S34. Incidentally, the one-way function circuit 520 is a circuit using a one-way function, in which input value can be hardly obtained from the output value.

The content encryption circuit 530 encrypts the contents S31 using the value (data) S34 output from the one-way function circuit 520 as the encryption key, and outputs the content encryption data S35.

Also, the key managing center 600 comprises a content key inputting circuit 610, a title key encryption circuit 620, an encryption key for decryption key inputting circuit 630 and a content key encryption circuit 640.

In accordance with the content playback region, the title key encryption circuit 620 encrypts the title key S32 using the content key (content encryption key) S41 input by the content key inputting circuit 610, and outputs title key encrypting data S42.

The content key encryption circuit 640 in the key managing center 600 encrypts the content key (here, it functions as the content decryption key) S41 using an encryption key for decryption key S43, which is input in accordance with the playback regions of the contents and the playback devices, which are permitted the playback by the encryption key for decryption key inputting circuit 630 in the key managing center 600, and outputs contents key encryption data S44.

Then, the content encryption data S35, the title data key conversion data S33 which is the part of data of the contents, the title key encryption data S42, and the content key encryption data S44 are recorded on an optical disk 501 or a master disk thereof.

On the other hand, the playback device 700 is provided with a decryption key storage device 710, a contents key decryption circuit 720, a title key decryption circuit 730, a one-way function circuit 740 and a content decryption circuit 750.

The decryption key storage device 710 stores a decryption key for decryption key S51 corresponding to the playback device 700. Reading out the optical disk 501, the content key decryption circuit 720 decrypts the read-out content key encryption data S44 using the decryption key for decryption key S51. At this time, when the playback device is the playback device 700 with which the playback is permitted, the content key decryption circuit 720 succeeds in the decryption. When the playback device 700 is not permitted the playback device, since the playback device 700 does not have the decryption key for decryption key S51 corresponding to the encryption key for decryption key S43, the playback device 700 fails in the decryption; thus, the contents cannot be decrypted.

Upon succeeding in the decryption, the content key decryption circuit 720 outputs content key data S52. The contents key data S52 is used as the decryption key in the title key decryption circuit 730 to decrypt a title key S53.

The decrypted title key S53 and the title key conversion data S33 are input to the one-way function circuit 740, which is the same as the one-way function circuit 520, and value S54, which is the same as the value S34, is output.

Then, the content decryption circuit 750 decrypts the contents encryption data S35 using the value S54 to output the contents.

### Effect of the Fourth Embodiment

According to the embodiment as described above, in place of encrypting the contents directly using the content encryption key, the contents are encrypted indirectly via the title key and the one-way function circuit 520. Accordingly, by changing the title key, the contents encryption data can be readily changed. Thus, the copyright protection function can be further enhanced. Particularly, even when the content key, which is set up based on playback region, is not changed, by changing the title key only, the contents encryption data can be changed. Accordingly, the title key can be changed frequently based on the kind of the contents; thus, the copyright protection function can be further enhanced.

The key managing center 600 may be established as an independent organization. Or, the key managing center 600 may be incorporated in the recording device 500 side; i.e., a copyright holder having the contents or a manufacturing company which manufactures the optical disk 501.

### Modification of the Embodiment

The present invention is not limited to the above-described embodiment. In a range that the object of the present invention is achieved, the following modifications are also included.

For example, as for the key management system of the encryption key for decryption key and the decryption key for decryption key, it is not limited to the key management system described in the first and second embodiments or to the tree pattern division system described in the third embodiment. For example, other key management system such as “the subset difference method” described in the above document 1 may be employed.

Also, as for the key management system, it is not always limited to the key management system using the tree structure; but other system may be employed. For example, other key management system as described below may be employed. That is, by previously preparing corresponding information between the encryption key for decryption key and the decryption key set up in each of the playback devices, and the playback regions to which each of such playback devices belongs, each of the content decryption keys are encrypted using the encryption keys for decryption key of the respective playback devices belonging to the regions where playback is permitted. In other words, it is acceptable when pairs of the encryption key for decryption key for encrypting the content decryption key and the decryption key for decryption key corresponding thereto are at least different from each other among the preset regions.

In its essence, when carrying out the embodiment, the management system of the encryption key for decryption key and the decryption key for decryption key provided to each of the playback devices to revoke each playback device can be appropriately selected, it is acceptable when the keys are managed at least as different keys among the playback regions.

In the case where the tree structure is employed, corresponding to the number of the playback devices to be revoked, the number of the keys used also can be controlled. Particularly, in an initial stage that the number of the playback devices to be revoked is small, the number of the keys used is very small. Thus, the key management can be carried out easily.

Further, the configuration of the recording device 100, 500 and the playback device 200, 700 is not limited to the above embodiments. In its essence, it is acceptable when the playback devices can encrypt the content data by directly or indirectly using the content encryption keys; and when the playback device can decrypt the encrypted data by directly or indirectly using the content decryption key.

In other words, in this invention, the wording “to encrypt the contents by using the content encryption key” means to encrypt the contents by directly or indirectly using the content key. Likewise, the wording “content decryption key used to decrypt the encrypted contents” means the key, which can decrypt the contents by directly or indirectly applying to the contents.

Furthermore, in the above embodiments, the content encryption key and the content decryption keys are arranged based on the regions where playback of the contents is permitted, or in accordance with the combination of regions where playback thereof is permitted, and when a playback device to be newly revoked is found, the keys are replaced with new ones. The keys may be arranged in accordance with the combination of the playback devices, which belong to a playback permitted region and permitted to play the contents. In this case also, since the playback devices themselves are divided based on playback region, the content encryption key and the content decryption key are resulted in different keys respectively based on at least playback region or the combination thereof. In this case, different from the flowchart in FIG. 20, each of the content encryption keys, the content decryption keys and the encryption keys for decryption key are set up after the playback regions and the playback devices are appointed.

Still further, the recording medium for recording the encrypted contents and the content decryption key is not limited to the optical disk. Various kinds of storage medium such as magnetic disk, magnetic tape, and memory card may be employed. The media recording section 180 of the recording device 100 and the information reading section 210 of the playback device 200 may be appropriately set up in accordance with the kind of the employed recording medium.

Still furthermore, the encrypted contents and the content decryption key may be recorded on a recording medium such as a magnetic disk, which is incorporated in a content delivery server as the information delivery device. By providing a delivery device to the content delivery server for delivering the encrypted contents and content decryption key recorded in the recording medium, it is possible to transmit encryption data of the content and content decryption key to the playback devices 200, which access thereto via the Internet or LAN. Preferably, each of the playback devices 200 receives the encryption data, decrypts and plays the data.

The content encryption key AE_{R} and the content decryption key AD_{R} are set up in accordance with the playback regions where playback is permitted or the combination thereof. And it is arranged so that, as the case of media 301 and 303, when a playback device to be revoked in the same playback region occurs, and when the combination of the playback devices permitted to playback the data is different from each other, different keys are used. However, it may be arranged so that, in such case also that the combination of permitted playback regions is the same and the combination of the playback devices to be permitted to playback the data, the different keys are used. The kind of the delivered contents is not limited to music data; but images and characteristic information such as news may be included. The contents may be appropriately set up corresponding to the customer needs. The kind of the contents may be appropriately selected when carrying out content delivery business.

The recording device 100 is not limited to an exclusive device combined with various kinds of hardware, but may be configured by providing an information recording program to a general purpose equipment such as a computer. Particularly, when the recording device 100 is configured by combining the information recording program with a computer having a drive capable of writing on a DVD-R or the like, a small amount of information recording media can be manufactured at a low cost.

The playback device 200 is not limited to an exclusive playback equipment such as a DVD playback equipment, but may be configured by combining an information playback program with a general purpose equipment such as a computer.

That is, as the playback device 200, for example, various kinds of exclusive equipment such as portable phone set having various kinds of wireless and/or cable communication functions, PDA (Personal Digital Assistant), audio equipment, car audio equipment and general-purpose equipment represented by PC are available.

To constitute the recording device 100 and the playback device 200 using the programs, the programs are installed in a computer or the like via a communication method as the Internet, or a recording medium such as a CD-ROM and a memory card, the CPU is caused to operate by the installed program.

The playback regions for managing the permission and inhibition of the content playback are ordinarily divided in accordance with regions, which are set up geographically such as municipality, prefecture, country and continent. However, for example, the regions may be set up based on other than geography, like the case where the management is carried out so that contents can be played by only a playback device of a particular manufacturer.

As for particular configuration for carrying out the present invention, configuration and/or procedures other than the above may be adapted in a range that the object of the present invention is achieved.

### INDUSTRIAL APPLICABILITY

The present invention is applicable to an information recording medium, an information recording device, an information playback device, an information delivery device, their method, their program and a recording medium recording the program. Particularly, the present invention is applicable to optical disks such as DVDs (Digital Versatile Disc) as a recording medium (information recording medium) recording contents (information and data) of multimedia data or the like such as music and images.

1. An information recording medium recording contents encrypted using a content encryption key, and a content decryption key used for decrypting the encrypted contents and encrypted by an encryption key for decryption key, wherein
the encryption key for decryption key is different for each of the regions preset for at least controlling the permission and inhibition of playback of the contents,
the content encryption key and the content decryption key are established corresponding to each of the regions where the content playback is permitted, or corresponding to the combination of the regions where content playback is permitted.

2. An information recording medium according to claim 1, wherein the content decryption key is encrypted by the one or more encryption keys for decryption key provided corresponding to the playback device with which the content playback is permitted.

3. An information recording medium according to claim 1, wherein header information indicating the kind of the encryption key for decryption key is further recorded therein.

4. An information recording medium according to claim 1, wherein the content encryption key and the content decryption key belong to an region where content playback is permitted, and are established corresponding to a combination of playback devices with which the content playback is permitted.

5. An information recording medium according to claim 1, wherein, when the content playback in a predetermined playback device is newly revoked, the content encryption key and the content decryption key are renewed to a new key respectively.

6. An information recording medium according to claim 1, wherein the encryption keys for decryption key are managed by a key management system using one or more tree structures provided independently for the each region.

7. An information recording medium according to claim 6, wherein the encryption keys for decryption key are managed by a key management system employing one or more tree structures for each of the regions in the state in which one encryption key specified for region independently provided to each of the regions is a root and encryption keys specified for playback device provided to each of the playback devices are the leaves.

8. An information recording medium according to claim 6, wherein each of the tree structures employs an n-divided tree (n≧2).

9. An information recording medium according to claim 6, wherein the encryption keys for decryption key are managed by a key management system employing an n-divided tree (n≧2) in the state in which one encryption key specified for region independently provided to each of the regions is a root and encryption keys specified for playback device, provided to each of the playback devices are the leaves.

10. An information recording device, comprising:
a content encryption key inputting section for establishing and inputting a content encryption key corresponding to each of the regions where playback of the contents is permitted, or corresponding to combination of the regions where content playback is permitted;
a content decryption key inputting section for establishing and inputting a content decryption key utilized for decrypting the contents encrypted by the content encryption key;
an encryption key for decryption key selecting section for selecting an encryption key for decryption key corresponding to the region where playback of the contents is permitted;
a content encryption section for encrypting the contents utilizing the content encryption key;
a content decryption key encrypting section for encrypting the content decryption key using the encryption key for decryption key, and
a recording section for recording at least the encrypted contents and the encrypted content decryption key to an information recording medium.

11. An information playback device for playing information including contents encrypted utilizing a content encryption key, and a content decryption key used for decrypting the encrypted contents and encrypted by an encryption key for decryption key, comprising:
a decryption key storing section storing a decryption key for decryption key for decrypting the content decryption key encrypted by the encryption key for decryption key;
a content decryption key decrypting section for decrypting the content decryption key by using the decryption key for decryption key;
a content decrypting section for decrypting the contents by utilizing the content decryption key, and
a playback section for playing the decrypted contents, wherein
the decryption keys for decryption key is different for each of the regions preset for at least controlling the permission and inhibition of the content playback,
the content encryption key and the content decryption key are established corresponding to each of the regions where content playback is permitted, or corresponding to the combination of the regions where content playback is permitted.

12. An information playback device according to claim 11, wherein the decryption key storing section stores therein plural kinds of decryption keys for decryption key including decryption keys specified for region established corresponding to regions where information playback devices belong to, and decryption keys specified for playback device allotted to each of the information playback devices.

13. An information playback device according to 12, wherein the plural kinds of decryption keys for decryption key are allotted and stored to each of the playback devices with the management of a key management system employing one or more tree structures independently provided for each of the regions.

14. An information playback device according to 13, wherein the decryption key for decryption key are managed by a key management system employing one or more tree structures for each of the regions in a state that a decryption key specified for region independently provided to each of the regions is the root and the decryption keys specified for playback device provided to each of the playback devices are leaves.

15. An information delivery device comprising:
a delivery section for delivering contents encrypted utilizing a content encryption key, and content decryption key used for decrypting the encrypted contents and encrypted by an encryption key for decryption key.

16. An information recording method, comprising the steps of:
obtaining selection information of the regions where playback of the contents is permitted,
establishing a content encryption key and a content decryption key corresponding to the selected regions or the combination thereof,
obtaining an encryption key for decryption key preset in accordance with the selected region,
encrypting the contents utilizing the content encryption key,
encrypting the content decryption key using the encryption key for decryption key, and
recording the encrypted contents and the encrypted content decryption key to an information recording medium.

17. An information recording method according to claim 16, further comprising a step of
establishing the encryption key for decryption key with a combination having the number smallest in a group of the encryption keys for decryption key, in which the encryption keys for decryption key owned by playback devices being permitted to play in a selected region is included, and the encryption key for decryption key owned by playback device being prohibited from playing is not included.

18. An information playback method for playing information including contents encrypted utilizing a content encryption key, and a content decryption key used for decrypting the encrypted contents and encrypted by an encryption key for decryption, wherein
the decryption key for decryption key is different for each of the regions preset at least for controlling the permission and inhibition of the content playback,
the content encryption key and the content decryption key are established corresponding to the each of the regions where content playback is permitted or, in accordance with the combination of regions where content playback is permitted,
the method comprising the steps of:
checking whether or not an information playback device has a decryption key for decryption key corresponding to the encryption key for decryption key encrypting the content decryption key,
decrypting the content decryption key using the decryption key for decryption key when the information playback device has the corresponding decryption key for decryption key,
decrypting the contents utilizing the decrypted content decryption key, and
playing the decrypted contents.

19. An information recording program, wherein the program causes a computer to execute the information recording method set forth in claim 16.

20. An information playback program, wherein the program causes a computer to execute the information playback method set forth in claim 18.

21. A recording medium recording an information recording program, wherein the information recording program set forth in claim 19 is recorded so as to be read out by a computer.

22. A recording medium recording an information playback program, wherein the information playback program set forth in claim 20 is recorded so as to be read out by a computer.
